(19) United States
(12) Patent Application Publication
(10) Pub. No.: US 2016/0279953 A1
(43) Pub. Date: Sep. 29, 2016

(54) LIQUID CARTRIDGE HAVING TARGET MEMBER PROVIDED WITH MAGNETIC BODY

(71) Applicant: BROTHER KOGYO KABUSHIKI KAISHA, Nagoya-shi (JP)

(72) Inventors: Mikio HIRANO, Okazaki-shi (JP); Takashi ITO, Nagoya-shi (JP)

(73) Assignee: BROTHER KOGYO KABUSHIKI KAISHA, Nagoya-shi (JP)

(21) Appl. No.: 15/009,930

(22) Filed: Jan. 29, 2016

(30) Foreign Application Priority Data
Mar. 27, 2015 (JP) 2015-066111

(51) Int. Cl. B41J 2/175

(52) U.S. Cl. CPC B41J 2/1752

(57) ABSTRACT

A liquid cartridge includes a liquid container, a target member disposed within a liquid chamber defined in the liquid container, an actuator movable between a restriction position and a non-restriction position, a first magnetic body provided on the target member and a second magnetic body provided on the actuator. The target member is movable between a detection position and a standby position, an arrival of the target member at the detection position being detectable from outside of the liquid container. The target member is movable from the standby position to the detection position in response to movement of the actuator from the restriction position to the non-restriction position, and is movable from the detection position to the standby position in response to movement of the actuator from the non-restriction position to the restriction position.

### CROSS REFERENCE TO RELATED APPLICATION

This application claims priority from Japanese Patent Application No. 2015-066111 filed Mar. 27, 2015. The entire content of the priority application is incorporated herein by reference.

### TECHNICAL FIELD

The present disclosure relates to a liquid cartridge storing liquid whose viscosity may change over time.

### BACKGROUND

There are conventional inkjet recording devices known in the art that are configured to record images on a recording medium by ejecting ink stored in an ink container through nozzles. In such a conventional inkjet recording device having this structure, issues such as clogged nozzles that could the affect image recording quality may occur when a viscosity of the ink in the ink container changes.

For example, Japanese Patent Application Publication No. H09-277560 discloses an inkjet recording device configured to calculate the viscosity of ink in the ink container and to perform a preliminary ink ejection operation suited to the calculated result. More specifically, this inkjet recording device calculates the viscosity of ink based on an amount of residual ink in the ink container and a length of time that has elapsed since the ink container was installed in the inkjet recording device.

### SUMMARY

However, changes in the viscosity of ink in an ink container may vary greatly depending on the type of ink in the ink container and ambient conditions, such as a temperature of an environment in which the ink container is located. Further, the inkjet recording device described above can only calculate how long an ink container has been mounted in the inkjet recording device and cannot accurately calculate the viscosity of ink in an ink container that has been stored for a lengthy time outside the inkjet recording device.

In view of the foregoing, it is an object of the present disclosure to provide a liquid cartridge capable of estimating a viscosity of liquid in a liquid chamber more directly.

In order to attain the above and other objects, the disclosure provides a liquid cartridge including a liquid container, a target member, an actuator, a first magnetic body, and a second magnetic body. The liquid container defines a liquid chamber therein for storing liquid. The target member is movably disposed within the liquid chamber and is movable within a predetermined range between a detection position and a standby position, an arrival of the target member at the detection position being detectable from outside of the liquid container. The actuator is movable between a restriction position and a non-restriction position. The first magnetic body is provided on the target member. The second magnetic body is provided on the actuator. The target member is movable from the standby position to the detection position in response to movement of the actuator from the restriction position to the non-restriction position. The target member is movable from the detection position to the standby position in response to movement of the actuator from the non-restriction position to the restriction position.

Incidentally, in the disclosure, “a state to be used (a usable state) of the liquid cartridge” denotes either a state of a liquid cartridge mounted in a liquid-consuming device and capable of being used thereby, or a state of a liquid cartridge during a manufacturing process thereof in which movement of the target member can be confirmed, for example.

In the liquid cartridge, part of the target member may function as a float, or alternatively, the target member itself may function as the float. Alternatively, in the liquid cartridge, part of the target member may function as a weight, or alternatively, the target member itself may function as the weight.

Note that the first magnetic body and second magnetic body may both be hard magnets (i.e., permanent magnets) or one of the magnetic bodies may be a hard magnet while the other is a soft magnet. Here, a soft magnet denotes a magnetic body that is relatively easy to demagnetize or reverse magnetize. That is, a soft magnet can produce a magnetic force for attracting a permanent magnet when the magnetic field of the permanent magnet is applied, since the soft magnet is relatively easily magnetized, but does not produce its own magnetic field and, thus, becomes demagnetized when outside the range of the magnetic field produced by the permanent magnet.

According to another aspect, there is provided a liquid-consuming device using the above liquid cartridge including the target member. The liquid-consuming device includes: the liquid cartridge described above; a cartridge-receiving section configured to detachably receive the liquid cartridge therein; a liquid-consuming section configured to consume the liquid supplied from the liquid cartridge received in the cartridge-receiving section; and a detector configured to output a detection signal containing information about the arrival of the target member at the detection position, the detection signal being outputted when the target member has arrived at the detection position.

Further, preferably, the liquid-consuming device using the above-described liquid cartridge may further include a controller configured to determine whether an elapsed period of time falls within a prescribed threshold range, the elapsed period of time being a time duration starting from a timing at which the actuator has moved to the non-restriction position until a timing at which the target member has arrived at the detection position.

Note that the “threshold range” in this specification need not be defined by both an upper limit and a lower limit, but may simply be defined by one of an upper limit and a lower limit. For example, a threshold range defined by only an upper limit includes all values less than or equal to the upper limit. Similarly, a threshold range defined only by a lower limit includes all values greater than or equal to the lower limit.

It is also preferable that the controller may be further configured to output a command to notify information on the mounted liquid cartridge when determining that the elapsed period of time falls outside of the prescribed threshold range.

There are no particular restrictions on how the controller provides the above notification. For example, the notification may indicate that the liquid in the liquid container mounted in the cartridge-receiving section has degraded or may recommend that the liquid cartridge be replaced. Further, the controller may restrict the liquid-consuming section from consuming the liquid supplied from the liquid container in order to avoid potential problems in the liquid-consuming section caused by use of liquid whose viscosity has changed greatly.

It is also preferable that: the liquid cartridge is an ink cartridge storing ink as the liquid; and the liquid-consuming section includes: a nozzle from which the ink is configured to be ejected; and an actuating element configured to control ejection of the ink from the nozzle when applied with a drive voltage; and the controller may be configured to adjust the drive voltage to be applied to the actuating element, depending on whether or not the elapsed period of time falls within the prescribed threshold range, such that a substantially constant amount of ink droplet can be ejected from the nozzle.

With the above structure, the drive voltages applied to the actuating elements are adjusted so that a quantity of ink to be ejected from the nozzles remains substantially uniform. Thus, when the cartridge-receiving section in the inkjet-recording device can accept different types of ink cartridges storing ink of different viscosities, for example, drive voltages suited to the types of ink can be applied to the actuating elements. However, the liquid-consuming device of the present disclosure is not limited to this example.

### BRIEF DESCRIPTION OF THE DRAWINGS

The particular features and advantages of the disclosure as well as other objects will become apparent from the following description taken in connection with the accompanying drawings, in which:

FIG. 1 is a cross-sectional view conceptually illustrating an internal construction of a printer 10 provided with a cartridge-receiving section 110 according to an embodiment;

FIG. 2 is a perspective view showing an external construction of an ink cartridge 30 according to the embodiment;

FIG. 3A is a vertical cross-sectional view conceptually illustrating the ink cartridge 30 and the cartridge-receiving section 110 according to the embodiment, and showing a state before an ink-supplying part 60 of the ink cartridge 30 is brought into contact with an inner back surface 151 of the cartridge-receiving section 110;

FIG. 3B is a vertical cross-sectional view conceptually illustrating the ink cartridge 30 and the cartridge-receiving section 110 according to the embodiment, and showing a state where the ink-supplying part 60 of the ink cartridge 30 is in contact with the inner back surface 151 of the cartridge-receiving section 110;

FIG. 4A is a vertical cross-sectional view conceptually illustrating the ink cartridge 30 and the cartridge-receiving section 110 according to the embodiment, and showing a state where an actuator 160 of the ink cartridge 30 is at a non-restriction position and a target member 59 of the ink cartridge 30 is at a standby position;

FIG. 4B is a vertical cross-sectional view conceptually illustrating the ink cartridge 30 and the cartridge-receiving section 110 according to the embodiment, and showing a state where the actuator 160 is at the non-restriction position and the target member 59 is at a detection position;

FIG. 5A is a vertical cross-sectional view conceptually illustrating the ink cartridge 30 and the cartridge-receiving section 110 according to the embodiment, and showing a state where the actuator 160 is at a restriction position and the target member 59 is at the detection position;

FIG. 5B is a vertical cross-sectional view conceptually illustrating the ink cartridge 30 and the cartridge-receiving section 110 according to the embodiment, and showing a state where the actuator 160 is at the restriction position and the target member 59 is at the standby position;

FIG. 6 is a diagram conceptually illustrating functional blocks of the printer 10 according to the embodiment;

FIG. 7 is a flowchart illustrating steps of a process according to the embodiment executed by a control unit 130 to determine whether viscosity of ink stored in an ink chamber 36 of the ink cartridge 30 is abnormal;

FIG. 8 is a flowchart illustrating steps of a process according to the embodiment executed by the control unit 130 when the process shown in FIG. 7 ends and a cover of the cartridge-receiving section 110 is closed;

FIG. 9 is a flowchart illustrating steps of a residual amount determining process according to the embodiment executed by the control unit 130;

FIG. 10A is a vertical cross-sectional view conceptually illustrating an ink cartridge 230 according to a first modification and the cartridge-receiving section 110, and showing a state where an actuator 260 of the ink cartridge 230 is at a restriction position and a target member 259 of the ink cartridge 230 is at a standby position; and

FIG. 10B is a vertical cross-sectional view conceptually illustrating the ink cartridge 230 according to the first modification and the cartridge-receiving section 110, and showing a state where the actuator 260 is at a non-restriction position and the target member 259 is at a detection position.

### DETAILED DESCRIPTION

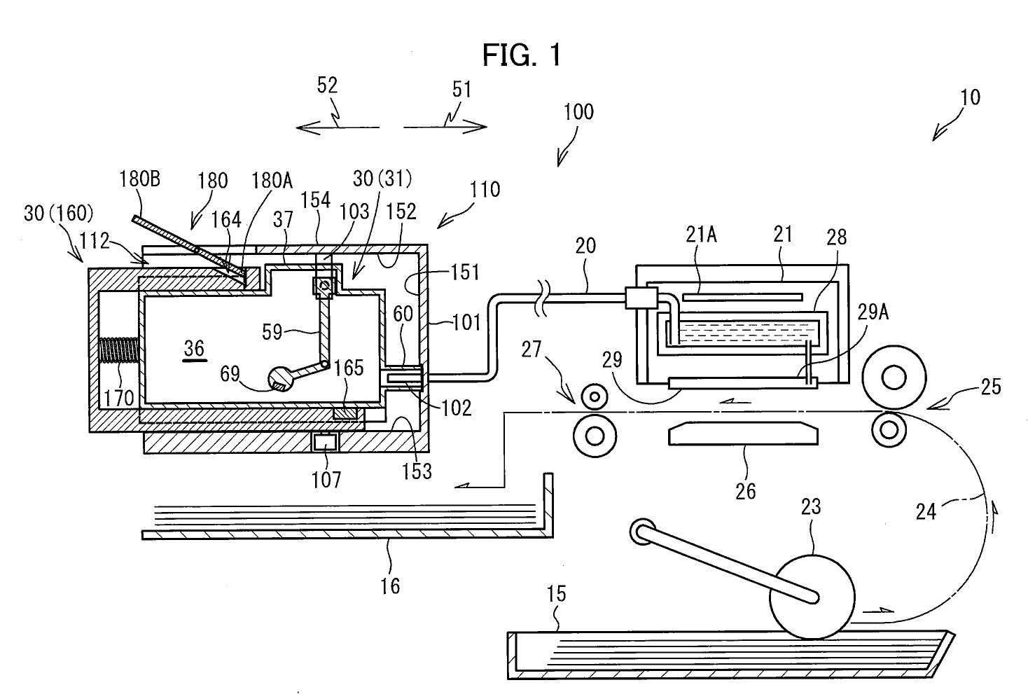

Hereinafter, a printer 10 having a cartridge-receiving section 110 and an ink cartridge 30 configured to be mounted into the cartridge-receiving section 110 according to an embodiment will be described first while referring to FIGS. 1 through 6.

In the following description, a mounting direction 51 is defined as the direction in which the ink cartridge 30 is inserted into the cartridge-receiving section 110, and a removing direction 52 is defined as the direction opposite the mounting direction 51 in which the ink cartridge 30 is extracted from the cartridge-receiving section 110. In the present embodiment, the mounting direction 51 and removing direction 52 are horizontal, but the mounting direction 51 and removing direction 52 need not be horizontal. Further, a downward direction 53 is defined as the direction of gravitational force acting on the ink cartridge 30 and an upward direction 54 is defined as the direction opposite the gravitational direction when the ink cartridge 30 has been inserted into the cartridge-receiving section 110, i.e., when the ink cartridge 30 is in a state to be used by the printer 10 or in a usable state. A rightward direction 55 and a leftward direction 56 are defined as directions orthogonal to the mounting direction 51 and downward direction 53 when the ink cartridge 30 is viewed in the removing direction 52. Unless otherwise stated, the following description will assume that the ink cartridge 30 is in its usable state.

<Overall Structure of Printer 10>

FIG. 1 shows the printer 10 as an example of a liquid-consuming device according to the embodiment. The printer 10 is configured to record images on recording sheets of paper by selectively ejecting ink droplets based on an inkjet-recording method. The printer 10 includes the cartridge-receiving section 110 (an example of a cartridge-receiving section), a recording head 21 (an example of a liquid-consuming section), an ink-supplying device 100, and ink tubes 20 connecting the recording head 21 to the ink-supplying device 100. Four ink cartridges 30 (an example of a liquid cartridge) corresponding to the four ink colors of cyan, magenta, yellow, and black can be mounted in the cartridge-receiving section 110. The cartridge-receiving section 110 has a surface in which an opening 112 is defined. The ink cartridges 30 can be inserted into the cartridge-receiving section 110 through the opening 112 in the mounting direction 51, or can be extracted from the cartridge-receiving section 110 in the removing direction 52. In FIG. 1, only one ink cartridge 30 (and the ink tube 20 corresponding thereto) is depicted for simplifying explanation.

The ink cartridges 30 can store ink (an example of liquid) that the printer 10 can use for printing. Each ink tube 20 connects each ink cartridge 30 to the recording head 21 when the ink cartridges 30 are completely mounted in the cartridge-receiving section 110. The recording head 21 is provided with four sub-tanks 28 corresponding to the four kinds of colors of the ink cartridges 30, and nozzles 29. Each sub-tank 28 is configured to temporarily hold ink to be supplied through the corresponding ink tube 20. The recording head 21 is configured to selectively eject the ink supplied from the respective sub-tanks 28 through the nozzles 29 according to the inkjet-recording method. More specifically, the recording head 21 is provided with a head control board 21A, and piezoelectric elements 29A (an example of an actuating element) corresponding one-on-one to the nozzles 29. The head control board 21A is configured to selectively apply drive voltages to the piezoelectric elements 29A in order to selectively eject ink from the nozzles 29. Hence, the piezoelectric elements 29A can eject ink from the corresponding nozzles 29 when driven by the head control board 21A.

The printer 10 further includes a sheet tray 15, a feeding roller 23, a conveying path 24, a pair of conveying rollers 25, a platen 26, a pair of discharge rollers 27, and a discharge tray 16. The feeding roller 23 feeds a recording sheet from the sheet tray 15 onto the conveying path 24, and the conveying rollers 25 convey the recording sheet over the platen 26. The recording head 21 selectively ejects ink onto the recording sheet as the recording sheet passes over the platen 26, whereby an image is recorded on the recording sheet. The discharge rollers 27 receive the recording sheet that has passed over the platen 26 and discharge the sheet into the discharge tray 16 provided on a downstream end of the conveying path 24.

<Ink-Supplying Device 100>

As shown in FIG. 1, the ink-supplying device 100 is provided in the printer 10. The ink-supplying device 100 functions to supply ink to the recording head 21 provided in the printer 10. The ink-supplying device 100 includes the cartridge-receiving section 110 in which the ink cartridges 30 can be mounted. The cartridge-receiving section 110 includes a case 101, an ink needle 102, an optical sensor 103 (an example of a detector), a mounting sensor 107, and a locking lever 180.

FIG. 1 illustrates the state of the ink cartridge 30 when completely mounted in the cartridge-receiving section 110. In other words, FIG. 1 shows the ink cartridge 30 in its usable state. It should be noted that, since the cartridge-receiving section 110 can accommodate four ink cartridges 30 corresponding to the four ink colors of cyan, magenta, yellow, and black, the cartridge-receiving section 110 is provided with four each of the ink needles 102, optical sensors 103, mounting sensors 107, and locking levers 180 to correspond with the four ink cartridges 30. However, for simplifying explanation, only one of the ink cartridges 30 is depicted in the drawings.

<Ink Needle 102>

As shown in FIG. 1, the opening 112 is formed in one side of the case 101. The case 101 has an inner back surface 151 positioned on a side opposite to the side at which the opening 112 is formed. The ink needle 102 protrudes in the removing direction 52 from the inner back surface 151 of the case 101. The ink needle 102 is disposed on the inner back surface 151 of the case 101 at a position for confronting an ink-supplying part 60 (an example of a liquid-supplying part) of the ink cartridge 30. The ink needle 102 is a tube-like needle formed of resin and has a liquid channel in a center of the tube that extends along a longitudinal dimension of the ink needle 102. The ink needle 102 has a protruding end (distal end) near which an opening is formed, and a base end connected to the ink tube 20. When the ink needle 102 is inserted into the ink-supplying part 60 of the mounted ink cartridge 30, ink in an ink chamber 36 described later (an example of a liquid chamber) flows through the ink needle 102 into the ink tube 20. Hence, ink in the ink chamber 36 is supplied from the ink cartridge 30 mounted in the cartridge-receiving section 110 to the recording head 21 through the ink-supplying part 60.

The printer 10 is also provided with a cover (not shown) for covering or exposing the opening 112 formed in the cartridge-receiving section 110. The cover is supported on the case 101 or on an enclosure of the printer 10 (not shown) so as to be capable of opening and closing thereon. When the cover is opened, the opening 112 is exposed to the outside of the printer 10. In this state, a user can insert the ink cartridge 30 into the cartridge-receiving section 110 through the opening 112, or can extract the ink cartridge 30 from the cartridge-receiving section 110. When the cover is closed, the opening 112 is covered and not exposed to the outside of the printer 10. In this state, the ink cartridge 30 cannot be inserted into or extracted from the cartridge-receiving section 110.

In this specification, the phrase “the ink cartridge 30 mounted in the cartridge-receiving section 110” signifies that at least part of the ink cartridge 30 is positioned inside the cartridge-receiving section 110 (and more accurately, inside the case 101). Consequently, an ink cartridge 30 that is being inserted into the cartridge-receiving section 110 can also be treated as the ink cartridge 30 mounted in the cartridge-receiving section 110.

However, when the state of the ink cartridge 30 is described as “completely mounted in the cartridge-receiving section 110” in this specification, the ink cartridge 30 is at least capable of supplying ink to the recording head 21. For example, this state may denote a state in which the ink cartridge 30 is locked in the cartridge-receiving section 110 and immovable, a state in which the ink cartridge 30 is positioned in the cartridge-receiving section 110 with the cover closed over the opening 112, or any such state in which the ink cartridge 30 is capable of being operated by the printer 10 to record images. Thus, the ink cartridge 30 that is completely mounted in the cartridge-receiving section 110 is in its usable state.

<Optical Sensor 103>

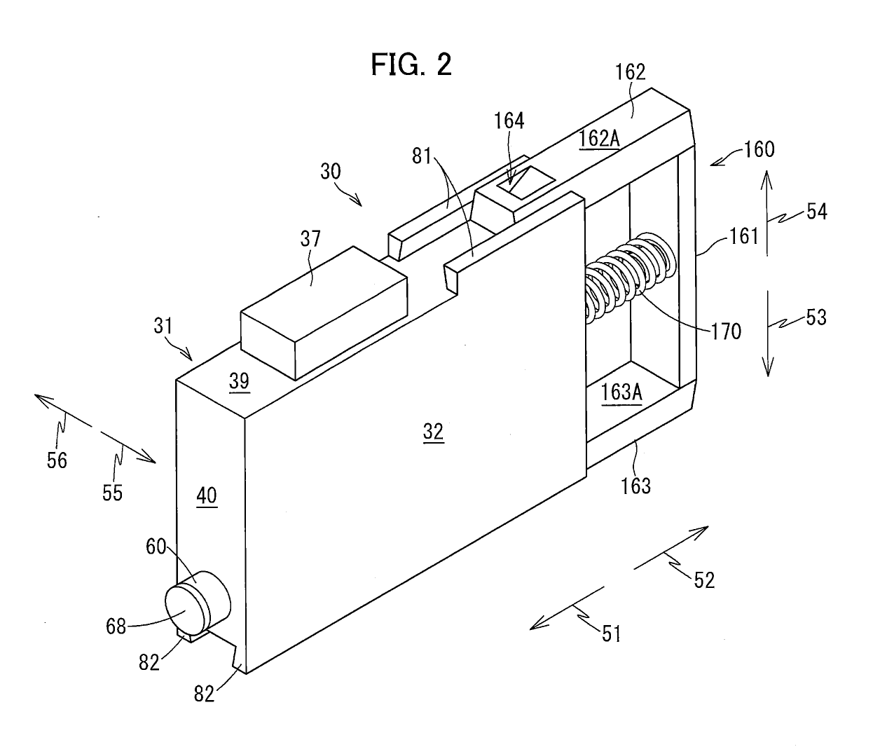

As shown in FIG. 1, the case 101 includes an inner top surface 152 that extends from a top edge of the inner back surface 151 of the case 101 to the opening 112. The optical sensors 103 protrude downward from the inner top surface 152 of the case 101. Each optical sensor 103 includes a light-emitting element and a light-receiving element. The light-emitting element is separated from the corresponding light-receiving element in either the rightward direction 55 or leftward direction 56 (see FIG. 2). When the ink cartridge 30 is completely mounted in the cartridge-receiving section 110, a protruding part 37 provided on a top surface of the ink cartridge 30 is positioned between the light-emitting element and light-receiving element of the corresponding optical sensor 103. In the embodiment, light outputted from the light-emitting element follows a path conforming to the rightward direction 55 and leftward direction 56.

The optical sensors 103 are configured to output detection signals that differ according to whether their respective light-receiving elements receive the light outputted from the corresponding light-emitting elements. For example, the optical sensor 103 outputs a low level signal (a signal having a level smaller than a threshold level) when the light-receiving element cannot receive light outputted from the corresponding light-emitting element (i.e., when the intensity of received light is less than a prescribed intensity). The optical sensor 103 outputs a high level signal (a signal having a level greater than or equal to the threshold level) when the light-receiving element can receive light outputted from the corresponding light-emitting element (i.e., when the intensity of received light is greater than or equal to the prescribed intensity). In the embodiment, the light-emitting element is configured to output visible or infrared light, for example, that can transmit through walls constituting the protruding part 37 provided on the ink cartridge 30 (i.e., an ink container 31 described later).

<Mounting Sensor 107>

As shown in FIG. 1, the case 101 includes an inner bottom surface 153 that extends from a bottom edge of the inner back surface 151 of the case 101 to the opening 112. The mounting sensors 107 are disposed in recesses formed in the inner bottom surface 153 of the case 101. Springs or other urging members (not shown) maintain the mounting sensors 107 in an elevated state so that a portion of each mounting sensor 107 protrudes upward from the inner bottom surface 153 of the case 101. The protruding portion of each mounting sensor 107 is withdrawn into the corresponding recess against an urging force of the spring or the like when pressed by a actuator 160 provided on the ink cartridge 30 when the ink cartridge 30 is mounted in the cartridge-receiving section 110.

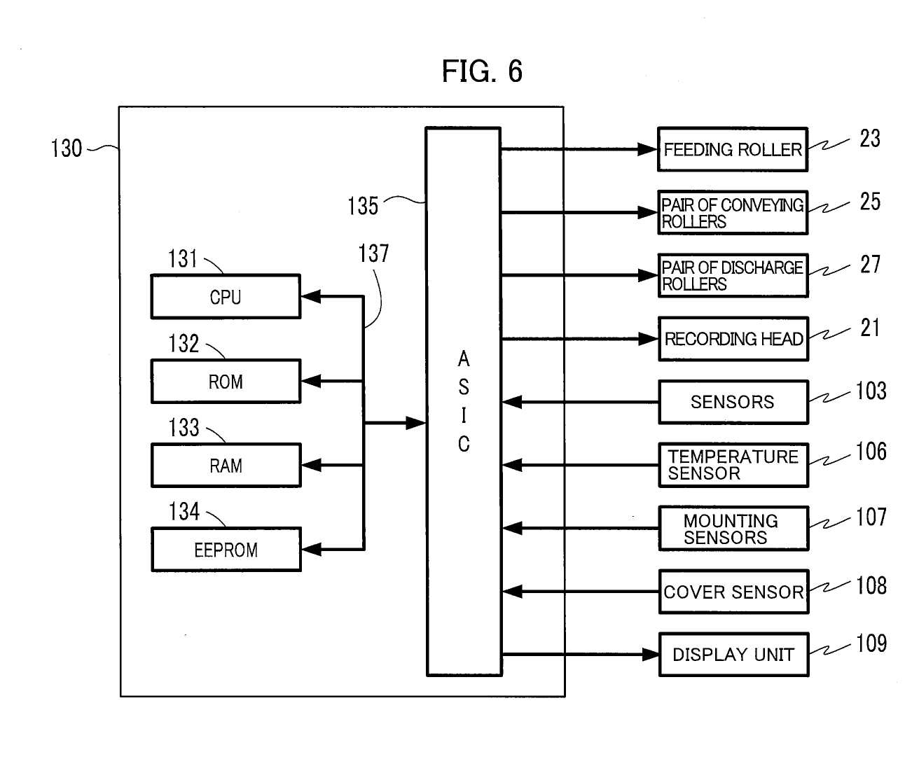

Each mounting sensor 107 is disposed at a mount-detection position in the cartridge-receiving section 110 along an insertion path of the corresponding ink cartridge 30. The mounting sensor 107 is configured to output a detection signal to a control unit 130 described later (see FIG. 6) whose signal level depends on whether an ink cartridge 30 is present at the mount-detection position. In the embodiment, the mounting sensors 107 are arranged so that the corresponding ink cartridges 30 are determined to be in their mount-detection positions when completely mounted in the cartridge-receiving section 110.

More specifically, each mounting sensor 107 outputs a low level signal when protruding from the inner bottom surface 153 of the case 101, i.e., when not pressed into the corresponding recess by the actuator 160 of the corresponding ink cartridge 30. The mounting sensor 107 outputs a high level signal when pressed by the corresponding actuator 160 so as not to protrude from the inner bottom surface 153 of the case 101. Thus, the mounting sensors 107 of the embodiment are mechanical sensors configured to output different detection signals depending on whether the mounting sensors 107 are pressed by the actuators 160 of the corresponding ink cartridges 30. However, the mounting sensors 107 are not limited to the example in this embodiment, but may be optical sensors or the like.

<Locking Lever 180>

As shown in FIG. 1, the case 101 includes a top wall 154 having the inner top surface 152. The locking levers 180 are pivotally movably supported at the top wall 154. Coil springs or other urging members (not shown) maintain the corresponding locking levers 180 in the state shown in FIG. 1 when no external force is being applied to the locking levers 180. Here, the state shown in FIG. 1 denotes the state of the locking lever 180 in which its engaging end 180A nearest the inner back surface 151 of the case 101 is offset from its operating end 180B farthest from the inner back surface 151 of the case 101 in the downward direction 53. When the ink cartridge 30 is completely mounted in the cartridge-receiving section 110, the engaging end 180A of the locking lever 180 is inserted into a corresponding recess 164 formed in the actuator 160 of the ink cartridge 30 (also see FIG. 2).

<Ink Cartridge 30>

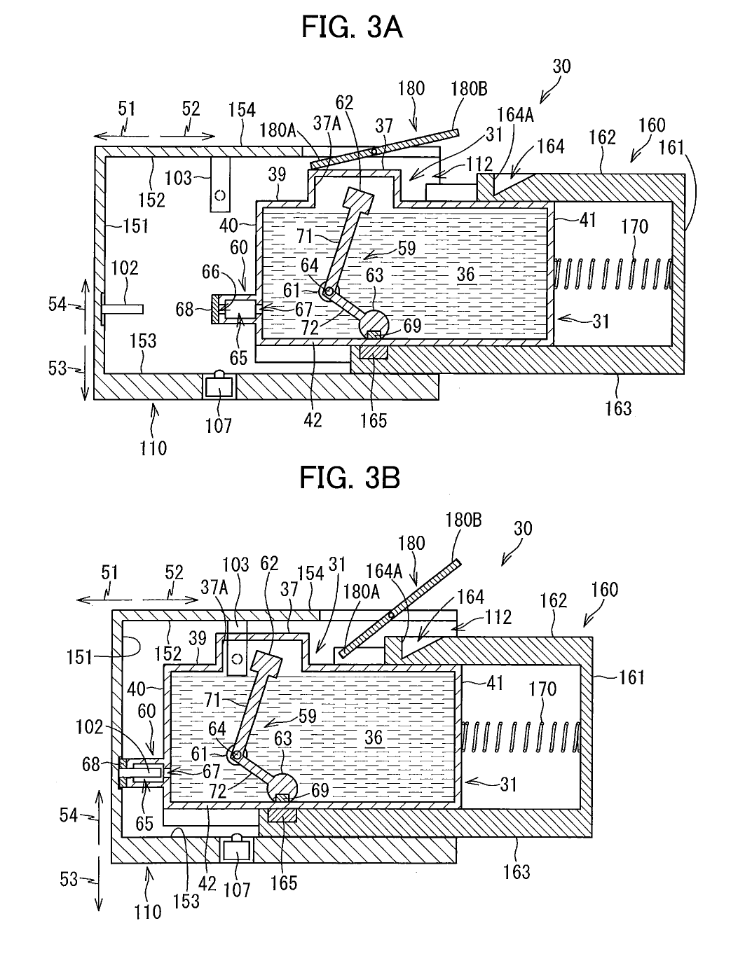

As shown in FIGS. 2 and 3, each ink cartridge 30 includes the ink container 31 (an example of a liquid container), a target member 59, and the actuator 160 coupled to the ink container 31. The ink container 31 defines the ink chamber 36 therein, and the target member 59 is disposed in the ink chamber 36. The ink cartridge 30 supplies ink stored in the ink chamber 36 externally through the ink-supplying part 60. When inserting the ink cartridge 30 into the cartridge-receiving section 110 in the mounting direction 51 or removing the ink cartridge 30 from the cartridge-receiving section 110 in the removing direction 52, the ink cartridge 30 is in an erected state shown in FIG. 3. In this erected state, the surface of the ink cartridge 30 facing in the downward direction 53 in FIG. 3 is the bottom surface and the surface of the ink cartridge 30 facing in the upward direction 54 is the top surface.

<Ink Container 31>

As shown in FIGS. 2 and 3, the ink container 31 has an external shape that is similar to a rectangular parallelepiped that appears flattened in the rightward direction 55 and leftward direction 56 so that a dimension of the ink container 31 in the rightward direction 55 and leftward direction 56 is small and dimensions of the ink container 31 in the downward direction 53 and upward direction 54 and the mounting direction 51 and removing direction 52 are greater than the dimension in the rightward direction 55 and leftward direction 56. The ink container 31 is configured of: a front wall 40 (an example of a first wall) and a rear wall 41 (an example of a second wall) that at least partially overlap each other when viewed in the mounting direction 51 or removing direction 52; and a top wall 39 (an example of a third wall) and a bottom wall 42 (an example of a fourth wall) that at least partially overlap each other when viewed in the downward direction 53 or upward direction 54. The front wall 40 is the side of the ink container 31 facing forward (facing in the mounting direction 51) when the ink cartridge 30 is mounted in the cartridge-receiving section 110, while the rear wall 41 is the side facing rearward (facing in the removing direction 52).

The top wall 39 is connected to top edges of the front wall 40 and the rear wall 41. The bottom wall 42 is connected to bottom edges of the front wall 40 and the rear wall 41. The protruding part 37 is provided on the top wall 39 and protrudes in the upward direction 54. As described above, the protruding part 37 can transmit light outputted from the light-emitting element of the optical sensor 103. It should be noted that: the top wall 39 including the protruding part 37 may transmit light outputted from the light-emitting element of the optical sensor 103; or alternatively, the ink container 31 as a whole may transmit light outputted from the light-emitting element of the optical sensor 103.

Surfaces (sides) of the ink container 31 facing in the rightward direction 55 and leftward direction 56 are open. These open surfaces of the ink container 31 are respectively sealed with films. As shown in FIG. 2, a film 32 seals the right surface of the ink container 31 (the surface that faces in the rightward direction 55). When the surface of the ink container 31 facing in the rightward direction 55 is viewed in a plan view, the film 32 has an outer shape that substantially conforms to the external shape of the ink container 31. Similarly, a film (not shown) sealing the left surface of the ink container 31 (the surface facing in the leftward direction 56) has an external shape that substantially conforms to the external shape of the ink container 31 when the side of the ink container 31 facing in the leftward direction 56 is viewed in a plan view. These films constitute the right and left walls of the ink chamber 36, respectively. The films are heat-sealed to the corresponding right and left edges of the top wall 39, front wall 40, rear wall 41, and bottom wall 42. Accordingly, ink can be stored in the ink chamber 36 defined by the top wall 39, front wall 40, rear wall 41, bottom wall 42, and left and right films. Note that the ink cartridge 30 may be further provided with covers for covering outer surfaces of the films to protect the films from external forces or impacts.

<Ink Chamber 36>

As shown in FIG. 3, the ink chamber 36 is formed between the front wall 40 and rear wall 41 for storing ink. The ink in the ink chamber 36 can flow out of the ink cartridge 30 through the ink-supplying part 60 by mounting the ink cartridge 30 in the cartridge-receiving section 110. The protruding part 37 has a hollow interior, forming a space in the protruding part 37. This internal space in the protruding part 37 is in communication with the ink chamber 36 to constitute a part of the ink chamber 36.

<Ink-Supplying Part 60>

As shown in FIG. 3, the ink-supplying part 60 is formed near the bottom edge of the front wall 40. The ink-supplying part 60 includes an ink supply chamber 65, an opening 66 providing communication between the ink supply chamber 65 and the exterior of the ink cartridge 30, an opening 67 providing communication between the ink supply chamber 65 and the ink chamber 36, and a stopper member 68. The opening 66 is formed in a wall defining an end of the ink supply chamber 65 facing in the mounting direction 51 and penetrates the wall defining this end in the mounting direction 51. The opening 67 is formed in another wall defining another end of the ink supply chamber 65 facing in the removing direction 52 and penetrates the wall defining this other end in the removing direction 52.

The stopper member 68 seals the opening 66. A slit (not shown) is formed in the stopper member 68 to allow insertion of the ink needle 102. When the ink needle 102 is inserted into the slit, the slit is forced to expand while the stopper member 68 forms a liquid-tight seal around an outer circumferential surface of the ink needle 102. Due to elasticity of the stopper member 68, the slit once again closes when the ink needle 102 is extracted from the slit.

While the ink needle 102 is inserted through the slit formed in the stopper member 68, the ink chamber 36 is in communication with the exterior of the ink cartridge 30 through the ink supply chamber 65 and the ink needle 102. Hence, the ink-supplying part 60 can supply ink stored in the ink chamber 36 to the outside of the ink cartridge 30.

<Target Member 59>

As shown in FIG. 3, the target member 59 is disposed in the ink chamber 36. The ink container 31 pivotally supports the target member 59 by, for example, a pair of walls (not shown) that protrude in the upward direction 54 from the bottom wall 42 and that oppose each other in the rightward direction 55 and leftward direction 56. Holes are formed in the walls, penetrating the walls in the rightward direction 55 and leftward direction 56. The target member 59 has a pivot center part 61 about which the target member 59 pivotally moves. Specifically, the pivot center part 61 is provided with a pair of protrusions 64, one on each end of the pivot center part 61, that protrude outward in the corresponding rightward direction 55 and leftward direction 56. The protrusions 64 are inserted into the holes formed in the above-described walls protruding in the upward direction 54 from the bottom wall 42. With this configuration, the target member 59 is pivotally movably supported by the ink container 31.

In addition to the pivot center part 61, the target member 59 includes a first arm 71, a second arm 72, a target portion 62, a float 63, and a magnet 69 (an example of a first magnetic body).

The pivot center part 61 is supported in the ink container 31, as described above. The first arm 71 extends radially outward from the pivot center part 61. The first arm 71 extends toward the top wall 39. The second arm 72 extends outward from the pivot center part 61 in a different radial direction of the pivot center part 61 than the first arm 71. The second arm 72 extends toward the bottom wall 42.

The target portion 62 is provided on a distal end of the first arm 71 and supported on the same. The target portion 62 has a plate shape and is formed of a material that can block light outputted from the light-emitting element. More specifically, when light outputted from the light-emitting element is incident on one of right and left surfaces of the target portion 62, the intensity of light leaving the other of the right and left surfaces of the target portion 62 and reaching the light-receiving element is less than a prescribed intensity, such as 0. The target portion 62 may be configured to completely block the passage of light traveling in the rightward direction 55 or leftward direction 56, to partially absorb the light, to deflect the light, or to entirely reflect the light. For example, the target portion 62 may be formed of a resin containing a pigment, may be a transparent or translucent member having a prism-like shape for refracting light, or may be a member whose surface has a reflective coating, such as an aluminum coating.

The float 63 is provided on a distal end of the second arm 72 and is supported thereon. Note that the float 63 may be provided in a position other than the distal end of the second arm 72, such as a midpoint between the distal end and a base end of the second arm 72. The float 63 is formed of a material having a lower specific gravity than the ink accommodated in the ink chamber 36. The float 63 has a dimension in the rightward direction 55 and leftward direction 56 that is greater than a dimension of the target portion 62 in the rightward direction 55 and leftward direction 56. In other words, the float 63 is wider than the target portion 62 in the rightward direction 55 and leftward direction 56.

The magnet 69 is typically a permanent magnet and is disposed on a side surface of the float 63 facing in the downward direction 53. The magnet 69 is arranged such that either the N pole or the S pole faces in the downward direction 53, while the other pole faces in the upward direction 54.

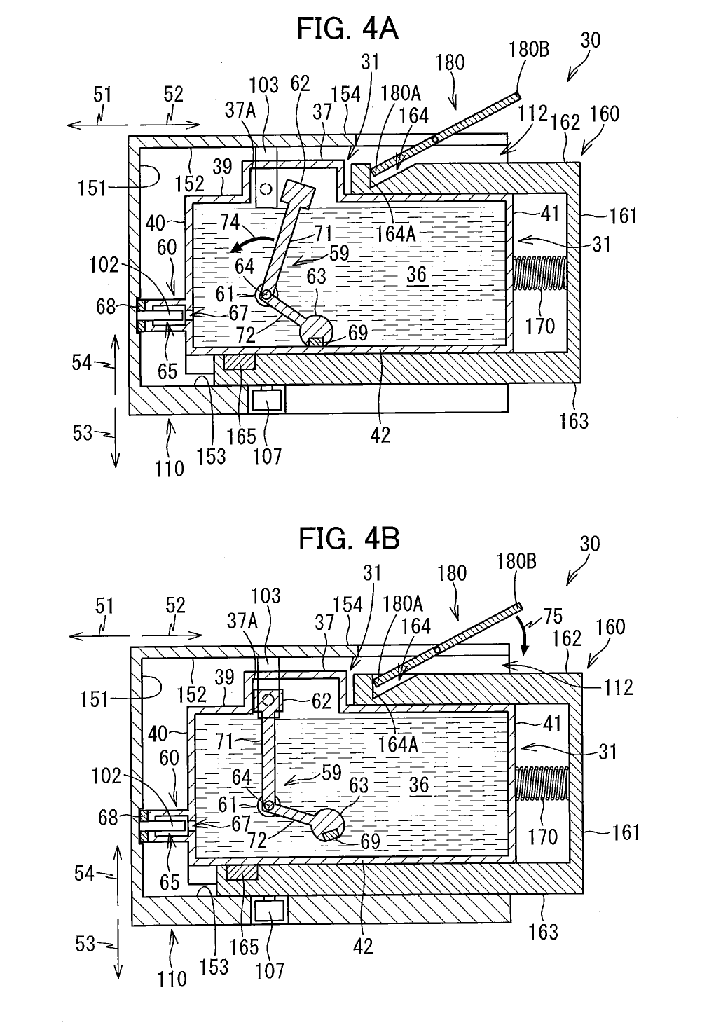

The target member 59 can pivot between a detection position shown in FIG. 4B and a standby position shown in FIG. 3A that is different from the detection position.

When the target member 59 is in the detection position, the target portion 62 is positioned between the light-emitting element and light-receiving element of the corresponding optical sensor 103. Since the target portion 62 blocks light emitted from the light-emitting element in this position, light is not incident on the light-receiving element, i.e., the intensity of light incident on the light-receiving element is less than the prescribed intensity. Therefore, when the target member 59 is in the detection position, the optical sensor 103 can detect the target portion 62 from outside the ink cartridge 30. The float 63 is also separated from the bottom wall 42 when the target member 59 is in the detection position.

When the target member 59 is not in the detection position, the target portion 62 is not positioned between the light-emitting element and light-receiving element of the corresponding optical sensor 103. Therefore, light outputted from the light-emitting element is incident on the light-receiving element, i.e., the intensity of light incident on the light-receiving element is greater than or equal to the prescribed intensity.

When the target member 59 is in the standby position, the float 63 is in contact with the bottom wall 42. Hence, the position of the float 63 is lower when the target member 59 is in the standby position than when the target member 59 is in the detection position. Note that the float 63 need not contact the bottom wall 42 when the target member 59 is in the standby position as long as the float 63 is lower when the target member 59 is in the standby position than when the target member 59 is in the detection position.

<Actuator 160>

As shown in FIGS. 2 and 3, the actuator 160 is provided on the outside of the ink container 31. The actuator 160 is connected to the rear wall 41 of the ink container 31 by a coil spring 170 (an example of a biasing member). That is, the coil spring 170 has one end connected to the rear wall 41, and another end connected to the actuator 160.

The actuator 160 is configured of a first plate 161 (an example of a first portion), a second plate 162 (an example of a second portion) and a third plate 163 (an example of a third portion). The other end of the coil spring 170 is connected to the first plate 161. The second plate 162 extends in the mounting direction 51 from a top end of the first plate 161, and the third plate 163 extends in the mounting direction 51 from a bottom end of the first plate 161.

The first plate 161 is arranged to face the outer surface of the rear wall 41 of the ink container 31 at a position offset from the outer surface in the removing direction 52. Hence, part of the actuator 160 is arranged to oppose the outer surface of the rear wall 41.

The second plate 162 is disposed on the top wall 39 of the ink container 31 to extend along the top wall 39. The recess 164 is formed in a top surface 162A of the second plate 162. The recess 164 can receive the insertion of the engaging end 180A of the locking lever 180 provided in the cartridge-receiving section 110, when the ink cartridge 30 is mounted in the cartridge-receiving section 110.

The third plate 163 is disposed on the bottom wall 42 of the ink container 31 to extend along the bottom wall 42. The third plate 163 has a top surface 163A in which a recess is formed for receiving a magnet 165 (an example of a second magnetic body) therein. The magnet 165 is typically a permanent magnet. The magnet 165 is disposed at a position near the magnet 69 of the target member 59 at the standby position, when the actuator 160 is at a restriction position described later. If the magnet 69 is oriented such that its N pole faces in the downward direction 53, the magnet 165 is oriented such that its S pole faces in the upward direction 54. Conversely, if the magnet 69 is oriented such that its S pole faces in the downward direction 53, the magnet 165 is oriented such that its N pole faces in the upward direction 54.

The actuator 160 can move relative to the ink container 31 in the mounting direction 51 and removing direction 52 between a restriction position (shown in FIGS. 3A and 3B) and a non-restriction position (shown in FIGS. 4A and 4B).

As shown in FIG. 2, the second plate 162 is disposed between a pair of ridges 81 formed on the top wall 39 of the ink container 31. Specifically, the ridges 81 extend along opposing edges of the top wall 39 in the rightward direction 55 and leftward direction 56 and protrude in the upward direction 54. The second plate 162 has a dimension greater than a dimension of the ridges 81 in the upward direction 54 and downward direction 53. The third plate 163 is disposed between a pair of ridges 82 provided on the bottom wall 42 of the ink container 31. The ridges 82 extend along right and left edges of the bottom wall 42 and protrude in the downward direction 53. The second plate 162 has a dimension larger than a dimension of the ridges 82 in the upward direction 54 and downward direction 53. This configuration allows the actuator 160 to move relative to the ink container 31 in the mounting direction 51 and removing direction 52, while restricting movement in the rightward direction 55 and leftward direction 56 to just a slight amount of play.

The coil spring 170 is at its natural length when the actuator 160 is in the restriction position. Thus, the actuator 160 is maintained at the restriction position as long as an external force is not applied thereto.

When the actuator 160 is at the restriction position, the magnet 165 is at approximately the same position as the magnet 69 of the target member 59 in the mounting direction 51 and removing direction 52. That is, the magnet 165 is positioned near the magnet 69. At this time, a magnetic force of attraction generated between the magnets 69 and 165 is greater than a force of buoyancy exerted by ink on the float 63 (and specifically, the net force on the float 63 in the upward direction 54 found by subtracting the gravitational force from the buoyancy). Put another way, the magnet 69 and the magnet 165 define such a distance therebetween that a magnetic field can be generated between the magnet 69 and the magnet 165, the magnetic field being greater than the buoyancy of the float 63 and providing the magnetic force (magnetic field of attraction) acting in a direction opposite the buoyancy.

Consequently, the magnet 69 is attracted to the magnet 165, and the target member 59 is pivoted into its standby position. Hence, the target member 59 is maintained at the standby position by the magnetic force of attraction (magnetic field) generated between the magnets 69 and 165.

When the actuator 160 is at the non-restriction position, the first plate 161 is positioned closer to the rear wall 41 of the ink container 31 than when the actuator 160 is at the restriction position. Accordingly, the coil spring 170 is compressed when the actuator 160 is at the non-restriction position. At this time, the coil spring 170 urges the actuator 160 toward the restriction position.

When the actuator 160 is at the non-restriction position, the magnet 165 is positioned offset in the mounting direction 51 from the magnet 69 in the target member 59. Thus, the magnet 165 is separated from the magnet 69. In other words, the magnet 165 moves away from the magnet 69 as the actuator 160 moves from the restriction position to the non-restriction position. Since the distance between the magnets 165 and 69 increases as the actuator 160 moves from the restriction position to the non-restriction position, the magnetic force of attraction generated between the magnets 69 and 165 also decreases until the magnetic force of attraction is smaller than the buoyancy exerted on the submerged float 63. As a result, when the float 63 is submerged in the ink, the buoyancy exerted on the float 63 causes the target member 59 to pivotally move from the standby position to the detection position. In other words, the target member 59 is allowed to pivot when the actuator 160 is in the non-restriction position. Put another way, movement of the actuator 160 from the restriction position to the non-restriction position causes the magnet 165 to move away from the magnet 69, thereby decreasing the magnetic force of attraction generated between the magnets 69 and 165 to move the detection member 59 from the standby position to the detection position.

The magnet 165 is moved toward the magnet 69 when the actuator 160 is moved from the non-restriction position toward the restriction position. Since the distance between the magnets 165 and 69 decreases as the actuator 160 moves from the non-restriction position to the restriction position, the magnetic force of attraction generated between the magnets 69 and 165 increases until the magnetic force of attraction becomes greater than the buoyancy exerted on the submerged float 63. As a result, this magnetic force of attraction causes the target member 59 to pivot from the detection position toward the standby position. Put another way, movement of the actuator 160 from the non-restriction position to the restriction position causes the magnet 165 to move toward the magnet 69, thereby increasing the magnetic force of attraction generated between the magnets 69 and 165 to move the detection member 59 from the detection position to the standby position.

<Control Unit 130>

The printer 10 is also provided with the control unit 130 as an example of a controller. As shown in FIG. 6, the control unit 130 includes a CPU 131, a ROM 132, a RAM 133, a EEPROM 134, and an application-specific integrated circuit (ASIC) 135, all of which components are connected via an internal bus 137. The ROM 132 stores programs and the like by which the CPU 131 can control various operations. The RAM 133 is used as a storage area for temporarily storing data, signals, and the like used when the CPU 131 executes the programs, or as a work area for data processes. The EEPROM 134 stores settings, flags, and the like that must be preserved after the power has been turned off. All or some of the CPU 131, ROM 132, RAM 133, EEPROM 134, and ASIC 135 may be configured on a single chip or may be spread over a plurality of chips.

The control unit 130 is electrically connected to the feeding roller 23, conveying rollers 25, discharge rollers 27, recording head 21, optical sensors 103, mounting sensors 107 as well as a temperature sensor 106 (an example of a temperature sensor), a cover sensor 108 and a display unit 109 provided in the printer 10.

The control unit 130 functions to drive a motor (not shown) for rotating the feeding roller 23, conveying rollers 25, and discharge rollers 27. The control unit 130 also controls the recording head 21 to eject ink from the nozzles 29. More specifically, the control unit 130 can output control signals to the head control board 21A indicating the magnitude of drive voltages to be applied to the corresponding piezoelectric elements 29A. The head control board 21A applies the drive voltages to the piezoelectric elements 29A provided for the nozzles 29 at magnitudes specified in the control signals acquired from the control unit 130 in order to eject ink from the corresponding nozzles 29. The control unit 130 can display information related to the printer 10 and ink cartridges 30 and various messages on the display unit 109.

The control unit 130 can also acquire the detection signals outputted from the optical sensors 103, the detection signals outputted from the mounting sensors 107, detection signals outputted from the temperature sensor 106, and detection signals outputted from the cover sensor 108. The temperature sensor 106 is configured to output signals corresponding to a detected temperature. The position at which the temperature sensor 106 measures the temperature is not particularly restricted, but should be in the interior of the cartridge-receiving section 110 or on the surface of the printer 10, for example. The cover sensor 108 is configured to output a signal that is different when the cover over the opening 112 in the cartridge-receiving section 110 is open and when the cover is closed.

<Operations for Mounting the Ink Cartridge 30 into the Cartridge-Receiving Section 110>

Next, movements of the target member 59 and actuator 160 while the ink cartridge 30 is being mounted in the cartridge-receiving section 110 will be described. In the following description, it will be assumed that the amount of ink stored in the ink chamber 36 is greater than an amount considered to be a near-empty condition described later.

Prior to the ink cartridge 30 being mounted in the cartridge-receiving section 110, the actuator 160 is in the restriction position shown in FIG. 3A, since no external force is being applied thereto. When the actuator 160 is in the restriction position, the target member 59 is held in the standby position by the magnetic force of attraction (magnetic field) generated between the magnets 69 and 165. Accordingly, the float 63 is submerged in the ink stored in the ink chamber 36.

When the target member 59 is in the standby position, the target portion 62 is not positioned between the light-emitting element and light-receiving element of the corresponding optical sensor 103 and, hence, light outputted from the light-emitting element is incident on the light-receiving element. Therefore, when the target member 59 is in the standby position, the optical sensor 103 outputs a high level signal to the control unit 130.

Prior to the ink cartridge 30 being mounted in the cartridge-receiving section 110, the actuator 160 is not pressing down on the corresponding mounting sensor 107 in the ink-supplying device 100. Accordingly, the mounting sensor 107 outputs a low level signal to the control unit 130.

From this state, the user opens the cover over the opening 112 in the cartridge-receiving section 110 and begins inserting the ink cartridge 30 into the cartridge-receiving section 110.

The user inserts the ink cartridge 30 into the cartridge-receiving section 110 by pushing the first plate 161 of the actuator 160 in the mounting direction 51. At this time, the third plate 163 of the actuator 160 slides over the inner bottom surface 153 of the case 101, but the ink container 31 does not contact the inner bottom surface 153 of the case 101 since the third plate 163 has the greater dimension in the upward direction 54 and downward direction 53 than the ridges 82 on the ink container 31. During the insertion of the ink cartridge 30 until the ink-supplying part 60 contacts the inner back surface 151 of the case 101, the ink container 31 and actuator 160 move together in the mounting direction 51 rather than relative to each other. During this insertion of the ink cartridge 30, the locking lever 180 slides over the protruding part 37 of the ink container 31 while being pivotally moved in the upward direction 54 by the top wall 39 (in the embodiment, by the protruding part 37 provided on the top wall 39) against the urging force of the not-illustrated urging member.

As the ink-supplying part 60 approaches the inner back surface 151 of the case 101 while moving in the mounting direction 51, as illustrated in FIG. 3B, the ink needle 102 enters through the stopper member 68 into the ink-supplying part 60. Through this operation, ink in the ink chamber 36 is allowed to flow out of the ink cartridge 30.

While the ink-supplying part 60 is in contact with the inner back surface 151 of the case 101 (see FIG. 3B), any force in the mounting direction 51 applied to the actuator 160 will cause the actuator 160 to move in the mounting direction 51 relative to the ink container 31 against a biasing force of the coil spring 170. Consequently, the actuator 160 moves from the restriction position toward the non-restriction position.

When the actuator 160 has moved into the non-restriction position as shown in FIG. 4A, the engaging end 180A of the locking lever 180 becomes inserted into the recess 164 formed in the second plate 162 of the actuator 160. At this time, the engaging end 180A of the locking lever 180 contacts a side surface 164A defining the recess 164 to prevent the actuator 160 from moving back to its restriction position from its non-restriction position due to the biasing force of the coil spring 170, even when a force in the mounting direction 51 is no longer being applied to the actuator 160. Through this arrangement, the actuator 160 is maintained in the non-restriction position.

When the actuator 160 has arrived at the non-restriction position shown in FIG. 4A, the third plate 163 of the actuator 160 pushes the mounting sensor 107 into its recess from above. Consequently, the mounting sensor 107 outputs a high level signal to the control unit 130, triggering a count to measure a moving time (described later) of the target member 59.

Further, when the actuator 160 is moved to the non-restriction position shown in FIG. 4A, the magnet 165 provided in the actuator 160 is separated from the magnet 69 provided in the target member 59. This separation reduces the magnetic force of attraction generated between the magnets 165 and 69 until the force is smaller than the buoyancy applied to the submerged float 63. Thus, the target member 59 pivots from the standby position toward the detection position.

The buoyancy exerted on the float 63 causes the target member 59 to pivotally move in a direction of a thick arrow 74 shown in FIG. 4A. The target member 59 continues to pivot until the target portion 62 contacts a surface 37A defining the internal space of the protruding part 37, as illustrated in FIG. 4B. When the target portion 62 contacts the surface 37A, the target member 59 is in the detection position shown in FIG. 4B.

When the target member 59 has arrived at the detection position, the target portion 62 is positioned between the light-emitting element and light-receiving element of the corresponding optical sensor 103. Accordingly, light outputted from the light-emitting element does not reach the light-receiving element, i.e., the intensity of light incident on the light-receiving element is less than the prescribed intensity. Hence, when the target member 59 is in the detection position, the optical sensor 103 outputs a low level signal to the control unit 130. That is to say, the optical sensor 103 outputs a low level signal (an example of a detection signal) indicating that the target member 59 is at the detection position. This signal triggers the end of the count used to measure the moving time (described later) of the target member 59. Once the above process is completed, the operation for mounting the ink cartridge 30 in the cartridge-receiving section 110 is complete.

Next, the movements of the target member 59 and actuator 160 while the ink cartridge 30 is extracted from the cartridge-receiving section 110 will be described. In the following description, the amount of ink stored in the ink chamber 36 is assumed to be greater than the amount signifying the near-empty condition described later.

Once the ink cartridge 30 has been completely mounted in the cartridge-receiving section 110 as shown in FIG. 4B, the locking lever 180 locks the actuator 160 in the non-restriction position. When the actuator 160 is at the non-restriction position, the target member 59 is at the detection position owing to the buoyancy applied to the submerged float 63.

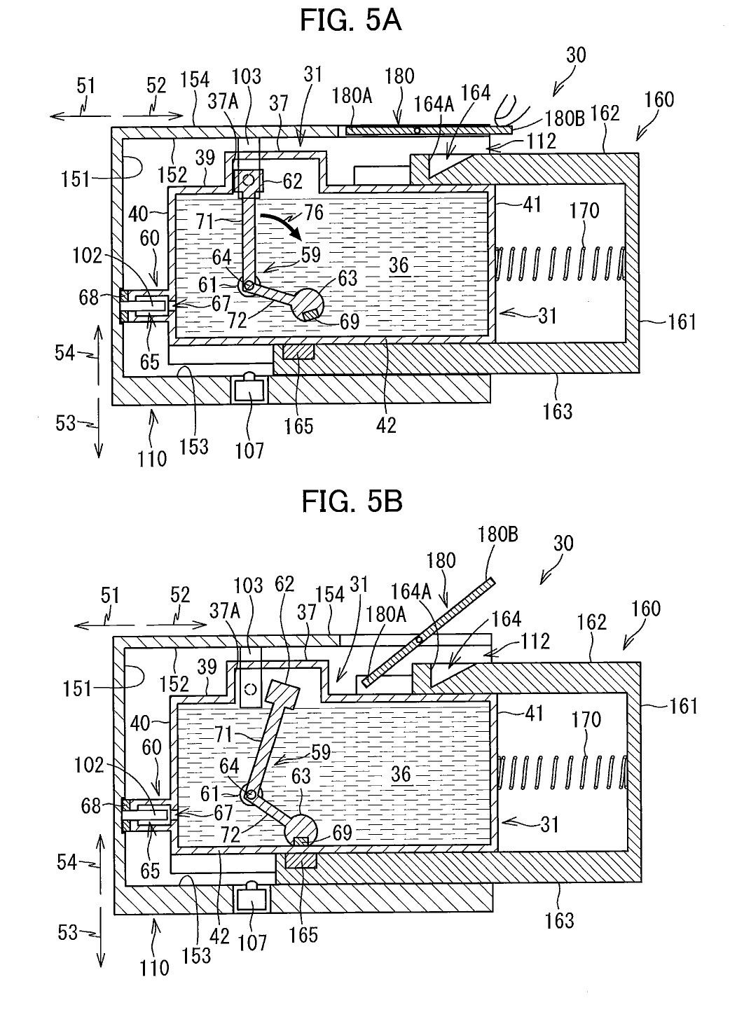

To initiate the process of extracting the ink cartridge 30, the user pushes down on the operating end 180B of the locking lever 180, causing the locking lever 180 to pivot in a direction of a thick arrow 75 shown in FIG. 4B. Through this action, the engaging end 180A of the locking lever 180 is extracted from the recess 164, allowing the biasing force of the coil spring 170 to move the actuator 160 from the non-restriction position toward the restriction position as shown in FIG. 5A.

When the actuator 160 is moved to the restriction position shown in FIG. 5A, the magnet 165 approaches the magnet 69, increasing the magnetic force of attraction (magnetic field) generated between the magnets 165 and 69 until the force is greater than the buoyancy exerted on the submerged float 63. Consequently, the target member 59 pivots from the detection position toward the standby position in a direction of a thick arrow 76 in FIG. 5A until arriving at the standby position shown in FIG. 5B.

Next, the movement of the target member 59 will be described for a case in which the ink cartridge 30 is completely mounted in the cartridge-receiving section 110 and ink in the ink chamber 36 has become depleted through repeated operations of the recording head 21.

Specifically, the ink stored in the ink chamber 36 is consumed as the recording head 21 ejects ink droplets from the nozzles 29 and, thus, the level of ink in the ink chamber 36 drops over the course of performing image-recording operations. As the level of ink drops below the float 63, the float 63 moves downward along with the surface level of the ink. Consequently, the target member 59 pivots in the direction of the thick arrow 76 shown in FIG. 5A as the ink level declines. In other words, the target member 59 pivots from the detection position toward the standby position. When the detection member 59 arrives at the standby position, the target portion 62 is retracted from its position between the light-emitting element and light-receiving element of the optical sensor 103. Accordingly, light outputted from the light-emitting element becomes incident on the light-receiving element, and the optical sensor 103 outputs a high level signal to the control unit 130 as a result. Upon receiving a high level signal from the optical sensor 103, the control unit 130 recognizes that the amount of residual ink in the ink chamber 36 has dropped to a prescribed amount. It should be noted that the target member 59 is already at the standby position at this time and would not pivot any further in the direction of the thick arrow 76 if the ink cartridge 30 were to be extracted from the cartridge-receiving section 110.

<How to Determine Whether Viscosity of Ink is Abnormal by the Control Unit 130>

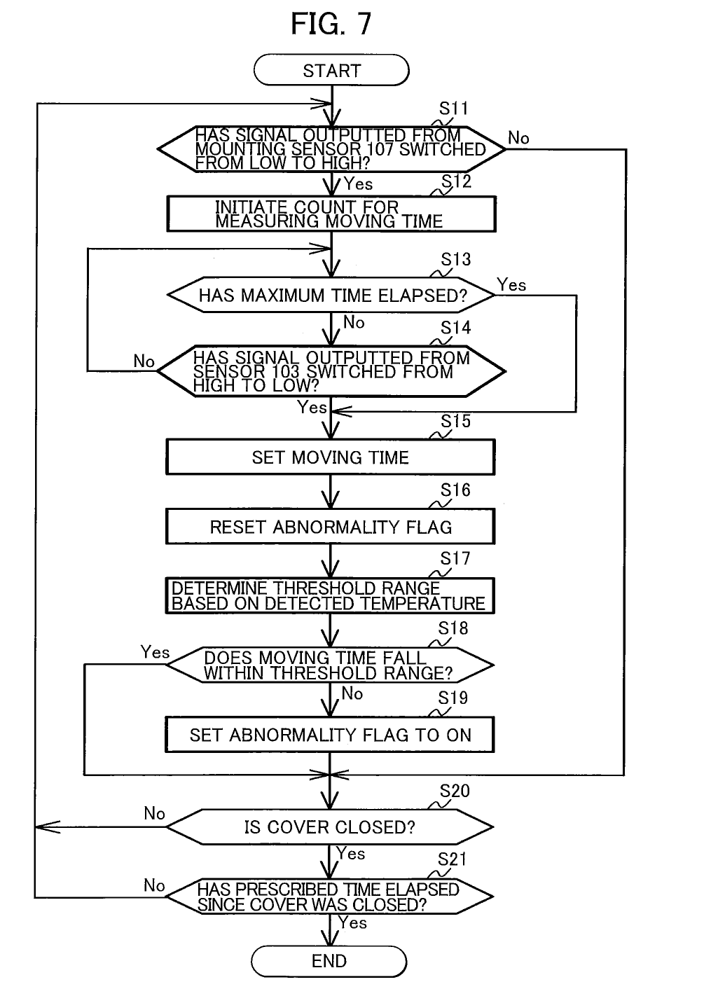

Next, a process executed by the control unit 130 for determining whether the viscosity of ink stored in the ink chamber 36 is abnormal will be described with reference to the flowcharts in FIGS. 7, 8, and 9.

In S11 of FIG. 7, the control unit 130 determines whether the detection signal outputted from the mounting sensor 107 has switched from a low level signal to a high level signal. When the detection signal has changed to a high level signal (S11: YES), in S12 the control unit 130 initiates a count for measuring the moving time of the target member 59. In the process of S11, the control unit 130 references the detection signal at prescribed intervals and determines that the detection signal has switched when the level of the detection signal at a certain timing differs from the level of the detection signal at the previous timing. If the detection signal outputted from the mounting sensor 107 has not changed from a low level signal to a high level signal (S11: NO), the control unit 130 advances to step S20 to execute a process described later. Here, the reason that the detection signal outputted from the mounting sensor 107 does not change from a low level signal to a high level signal may be because a new ink cartridge 30 has not yet been mounted in the cartridge-receiving section 110, for example.

After initiating the count in S12, in S13 the control unit 130 determines whether the amount of time after the count was initiated (elapsed period of time) exceeds a predetermined maximum time. If the maximum time has already elapsed (S13: YES), the control unit 130 advances to S15 and executes a process described later. Here, the maximum time may elapse before the detection signal outputted from the optical sensor 103 has changed from a high level signal to a low level signal when the viscosity of the ink stored in the ink chamber 36 is very high.

If the maximum time has not yet elapsed (S13: NO), in S14 the control unit 130 determines whether the detection signal outputted from the optical sensor 103 has changed from a high level signal to a low level signal. While the detection signal outputted from the optical sensor 103 has not changed (S14: NO), the control unit 130 repeats the determination in S13. When the control unit 130 determines that the detection signal outputted from the optical sensor 103 has changed to a low level signal (S14: YES), the control unit 130 halts the count for measuring the moving time of the target member 59 and in S15 sets the counted time as the moving time of the target member 59. If the control unit 130 advances to S15 because the maximum time has elapsed (S13: YES), the control unit 130 then sets the moving time of the target member 59 to this maximum time.

The moving time indicates a period of time required for the detection signal outputted from the optical sensor 103 to change from a high level signal to a low level signal (S14: YES) after determining that the detection signal outputted from the mounting sensor 107 has changed from a low level signal to a high level signal (S11: YES).

Strictly speaking, the timing at which the detection signal outputted from the mounting sensor 107 changes from a low level signal to a high level signal may not be synchronous with the timing at which the target member 59 starts pivoting from the standby position toward the detection position due to the separation of the magnet 69 and magnet 165. However, since the former timing and latter timing occur very close together, the latter timing may be treated as the former timing. Therefore, the control unit 130 calculates the period of time from the moment at which a high level signal is acquired from the mounting sensor 107 to the moment at which a low level signal is acquired from the optical sensor 103 to be the moving time of the target member 59, i.e., the period of time (time duration) required for the target member 59 to move from its standby position to its detection position.

In S16 the control unit 130 resets an abnormality flag (i.e., sets the flag to OFF). The abnormality flag may be later set to ON after determining in S18 described later that the moving time does not fall within a threshold range (S18: NO). An abnormality flag is set for each of the ink cartridges 30. The control unit 130 stores the abnormality flags in the EEPROM 134.

In S17 the control unit 130 determines the threshold range based on the signal outputted from the temperature sensor 106. The threshold range is used for comparison with the moving time measured in S15 in order to estimate the viscosity of ink stored in the ink chamber 36. The control unit 130 adjusts at least one of an upper limit and a lower limit of the threshold range based on the temperature identified in the signal outputted from the temperature sensor 106. That is, the control unit 130 reduces at least one of the upper limit and lower limit for higher temperatures, and increases at least one of the upper limit and lower limit for lower temperatures.

In S18 the control unit 130 determines whether the moving time of the target member 59 measured in S15 falls within the threshold range set in S17. Here, the ink viscosity is considered too low when the moving time falls below the lower limit of the threshold range and is considered too high when the moving time exceeds the upper limit of the threshold range. If the moving time falls outside the threshold range (S18: NO), in S19 the control unit 130 sets the abnormality flag to ON and proceeds to S20. However, if the moving time falls within the threshold range (S18: YES), the control unit 130 skips the process in S19 and proceeds to S20.

In S20 the control unit 130 determines whether the signal outputted from the cover sensor 108 indicates that the cover for covering the opening 112 in the cartridge-receiving section 110 is closed. If the control unit 130 determines that the cover is open (S20: NO), the control unit 130 repeats the above process from S11. However, if the control unit 130 determines that the cover is closed (S20: YES), in S21 the control unit 130 determines whether a prescribed period of time has elapsed after determining in S20 that the cover was closed.

If the control unit 130 determines that the prescribed period of time has elapsed (S21: YES), the control unit 130 ends the process of FIG. 7. However, if the prescribed period of time has not yet elapsed (S21: NO), the control unit 130 repeats the above process from S11. Note that if the control unit 130 subsequently determines in S20 that the cover has been opened after repeating the above process from S11 (S20: NO), the control unit 130 stops the time measurement that was initiated when the cover was determined to be closed (S20: YES).

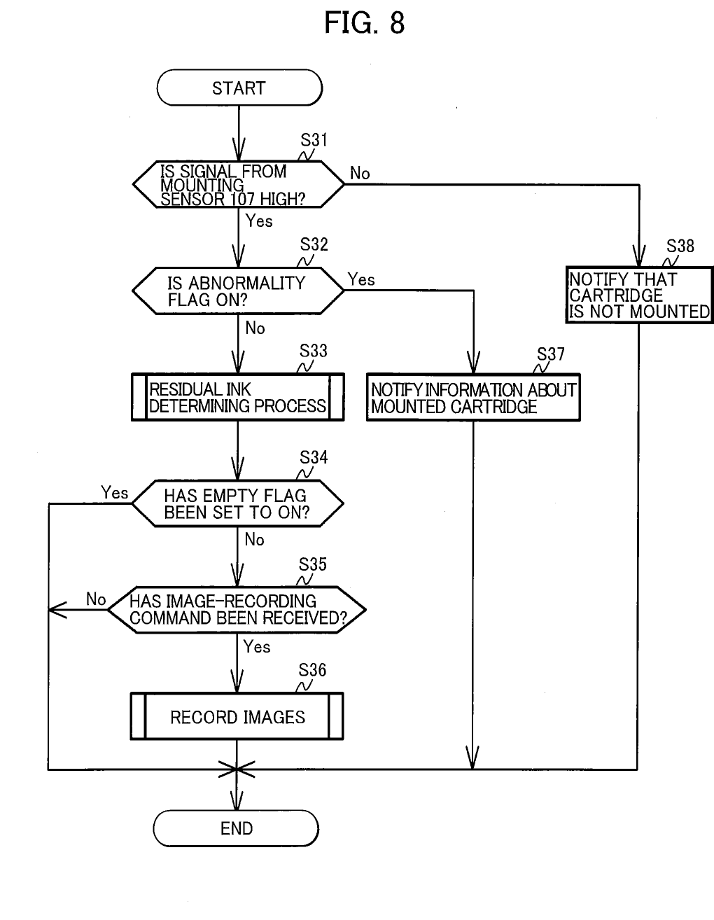

After completing the process shown in FIG. 7, the control unit 130 repeatedly executes the process shown in FIG. 8 at prescribed intervals as long as the cover sensor 108 is outputting a signal indicating that the cover is closed over the opening 112 formed in the cartridge-receiving section 110.

In S31 of FIG. 8, the control unit 130 first determines whether the detection signal outputted from the mounting sensor 107 is a high level signal. If the detection signal is a low level signal (S31: NO), in S38 the control unit 130 outputs a command to notify the user that the ink cartridge 30 is not mounted in the cartridge-receiving section 110 and subsequently ends the process of FIG. 8. There are no particular restrictions on a specific method of notification in this case, but the control unit 130 may control the display unit 109 to display a message thereon or may output an instructional voice message from a speaker (not shown) provided in the printer 10, for example.

However, if the detection signal outputted from the mounting sensor 107 is a high level signal (S31: YES), in S32 the control unit 130 determines whether the abnormality flag is set to ON. If the abnormality flag is set to ON (S32: YES), in S37 the control unit 130 outputs a command to provide the user with information about the ink cartridge 30, and subsequently ends the process of FIG. 8. While there are no particular restrictions on a specific content of the notification, the control unit 130 may provide the user with information related to the degradation of ink in the ink chamber 36 or recommend that the user replace the ink cartridge 30, for example. The method of notification may be similar to the method described for S38.

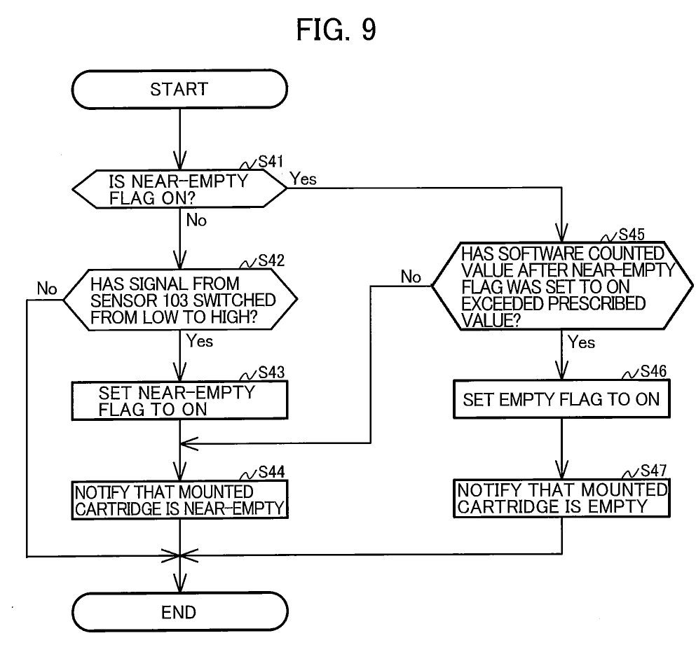

On the other hand, if the abnormality flag is set to OFF (S32: NO), in S33 the control unit 130 executes a residual ink determining process described later with reference to FIG. 9. After completing the residual ink determining process, in S34 the control unit 130 determines whether an empty flag has been set to ON. The empty flag is set to ON when it has been determined that the amount of ink stored in the ink chamber 36 has decreased to a degree that is insufficient for executing image-recording operations.

If the empty flag is set to ON (S34: YES), the control unit 130 ends the process of FIG. 8. However, if the empty flag is set to OFF (S34: NO), in S35 the control unit 130 determines whether an image-recording command has been received. If an image-recording command has not been received (S35: NO), the control unit 130 ends the process of FIG. 8. However, if an image-recording command has been received (S35: YES), in S36 the control unit 130 controls the recording head 21, feeding roller 23, conveying rollers 25, discharge rollers 27, and the like directly or indirectly to record images on recording sheets of paper, and subsequently ends the process of FIG. 8. Note that the process of S36 may be considered complete after an image-recording process has been performed for one sheet of recording paper or after an image-recording process has been performed for all acquired image data.

As described above, the control unit 130 does not execute the image-recording process of S36 when the abnormality flag is set to ON (S32: YES). In other words, the control unit 130 skips step S36 when the ink viscosity is abnormal. Consequently, the control unit 130 does not eject ink from the recording head 21, thereby restricting the recording head 21 from using degraded ink.

Next, the residual ink determining process will be described with reference to FIG. 9. In S41 of FIG. 9, the control unit 130 first determines whether a near-empty flag is ON. The near-empty flag is set to ON when it has been determined that the amount of ink stored in the ink chamber 36 is getting low but is still sufficient for executing an image-recording process. In other words, the amount of ink stored in the ink chamber 36 when the near-empty flag is set to ON is greater than the amount of ink stored in the ink chamber 36 when the empty flag is set to ON.

If the near-empty flag is set to OFF (S41: NO), in S42 the control unit 130 determines whether the detection signal outputted from the optical sensor 103 has switched from a low level signal to a high level signal. If the control unit 130 determines that the detection signal has not changed (S42: NO), the control unit 130 ends the residual ink determining process and returns to S34 in FIG. 8. However, if the detection signal outputted from the optical sensor 103 has changed (S42: YES), in S43 the control unit 130 sets the near-empty flag to ON. In S44 the control unit 130 notifies the user that the ink cartridge 30 is in a near-empty condition and subsequently ends the process of FIG. 9. Thereafter, the control unit 130 returns to S34 in FIG. 8. The near-empty condition described above is a condition in which the quantity of ink stored in the ink chamber 36 is getting low but is still sufficient for executing an image-recording process.

If the control unit 130 determines in S41 that the near-empty flag is set to ON (S41: YES), in S45 the control unit 130 determines whether a count value counted in software after the near-empty flag was set to ON has exceeded a prescribed value. The count value is calculated based on data on ink ejection commands that the control unit 130 has outputted to the recording head 21 after the near-empty flag was set to ON. More specifically, the count value is found by calculating the product of the number of ink droplets ejected from the recording head 21 in response to a command from the control unit 130 and the quantity of ink in each ink droplet specified by the control unit 130 and accumulating these products for all commands. The prescribed value is a value used for comparison with the count value.

If the count value from the moment the near-empty flag was set to ON is less than the prescribed value (S45: NO), i.e., if the quantity of ink consumed by the recording head 21 after the near-empty flag was set to ON is less than a prescribed quantity, the control unit 130 executes the process in S44 described above.

However, if the count value counted after the near-empty flag was set to ON is greater than or equal to the prescribed value (S45: YES), i.e., if the quantity of ink consumed by the recording head 21 after the near-empty flag was set to ON is greater than or equal to the prescribed quantity, in S46 the control unit 130 sets the empty flag to ON. In S47 the control unit 130 outputs a command to notify the user that the ink cartridge 30 is in an empty condition, and subsequently ends the process of FIG. 9. Thereafter, the control unit 130 returns to S34 in FIG. 8. The empty condition described above is a condition in which the amount of ink stored in the ink chamber 36 has dropped to a level insufficient for executing an image-recording process.

Note that there are no particular restrictions on a specific method of notifying the user in steps S44 and S47. For example, the control unit 130 may control the display unit 109 to display a message thereon or may output a command to output an instructional voice message from a speaker (not shown) provided in the printer 10.

<Operations and Advantageous Effects of the Embodiment>

In the embodiment described above, the target member 59 moves from the standby position to the detection position when the actuator 160 moves from the restriction position to the non-restriction position. Since the target member 59 moves through ink and incurs viscous and inertial resistance therein, the moving speed of the target member 59 is dependent on the viscosity of the ink. Therefore, the viscosity of the ink stored in the ink cartridge 30 can be estimated by measuring the period of time required for the target member 59 to arrive at the detection position after the actuator 160 has moved to the non-restriction position. In addition, the target member 59 is returned to the standby position when the actuator 160 moves back from the non-restriction position to the restriction position owing to the magnetic force of attraction (magnetic field) generated between the magnets 69 and 165. Thus, the viscosity of ink in the ink cartridge 30 can be repeatedly estimated.

In this way, it is possible to estimate the degree to which ink in the ink cartridge 30 has degraded when the ink cartridge 30 has been stored for a long period of time without being mounted in the printer 10. It is also possible to identify the type of ink cartridge 30 mounted in the printer 10 when a plurality of types of ink cartridges 30 storing inks of differing viscosities can be mounted in the printer 10.

Since the actuator 160 is provided on the outside of the ink container 31 in the embodiment, both of mounting of the ink cartridge 30 in the printer 10 and moving the actuator 160 from the restriction position to the non-restriction position can be realized simply by pushing the actuator 160 toward the front wall 40 of the ink container 31 with the ink-supplying part 60 of the ink cartridge 30 facing the ink needle 102 in the printer 10.

In the embodiment described above, the first plate 161 of the actuator 160 is positioned closer to the rear wall 41 of the ink container 31 when the actuator 160 is in the non-restriction position than when the actuator 160 is in the restriction position. Therefore, the actuator 160 can be moved from the restriction position to the non-restriction position through a user operation for mounting the ink cartridge 30 in the printer 10. Accordingly, the viscosity of ink can be estimated when the ink cartridge 30 is mounted in the printer 10.

Further, in the embodiment described above, the float 63 has a wider width than the target portion 62 in the rightward direction 55 and leftward direction 56. In other words, the float 63 has a width larger than a width of the target portion 62 in a direction perpendicular to a direction in which the detection member 59 moves from the standby position to the detection position. Accordingly, space can be easily allocated in the float 63 for disposing the magnet 69.

Since the target member 59 is capable of pivoting in the depicted embodiment, the target member 59 can be made to move over a longer distance in a small space than if the target member 59 were to move linearly. Since this longer moving distance increases the moving time of the target portion 62 from the standby position to the detection position, the viscosity of ink can be estimated with greater precision.

The viscosity of ink also varies according to ambient temperature. That is, viscosity tends to decrease when the temperature rises and to increase when the temperature drops. The control unit 130 controls the head control board 21A to adjust the drive voltages applied to the piezoelectric elements 29A based on temperature. Specifically, the control unit 130 outputs a control signal to the head control board 21A to apply lower drive voltages to the piezoelectric elements 29A when the temperature is high and outputs a control signal to the head control board 21A to apply higher drive voltages to the piezoelectric elements 29A when the temperature is low.

There are suitable threshold values for ink viscosity associated with drive voltages applied to the piezoelectric elements 29A. Therefore, it is preferable to set the threshold range for ink viscosity based on ambient temperature. Accordingly, a suitable threshold range for ink viscosity is set based on the ambient temperature in the depicted embodiment. While there is no particular restriction on a method of setting the threshold range, a threshold range corresponding to the ambient temperature may be selected from a plurality of threshold ranges pre-stored in the ROM 132 or the like, or the control unit 130 may calculate the upper limit or lower limit of the threshold range using a function that has temperature as an input parameter. Further, if the drive voltages applied to the piezoelectric elements 29A are not adjusted based on temperature, step S17 for setting the threshold range based on the signal outputted from the temperature sensor 106 may be omitted and a fixed threshold range may be used.

<First Modification>

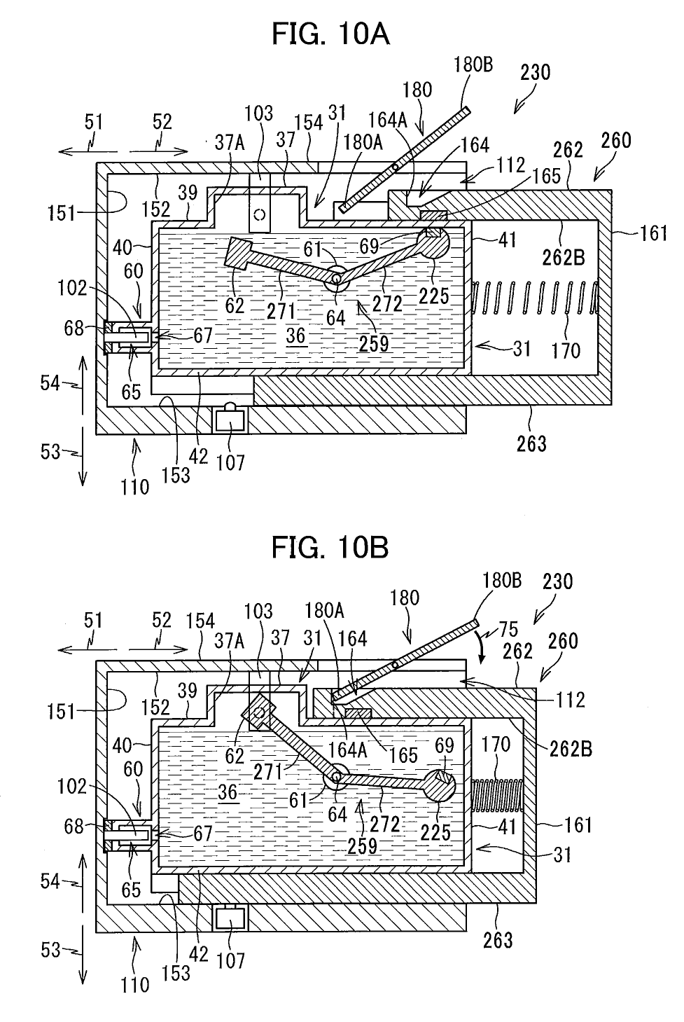

In the embodiment described above, the target member 59 is configured to move from the standby position to the detection position by utilizing the buoyancy of the float 63. Alternatively, the detected member of the embodiment may be configured to move from a standby position to a detection position by utilizing sinking movement of a weight, as will be described next as a first modification of the embodiment with reference to FIGS. 10A and 10B.

In the following description, while like parts and components are designated with the same reference numerals as those in the embodiment, parts and components different from those of the embodiment will be described in greater detail.

As shown in FIGS. 10A and 10B, an ink cartridge 230 according to the first modification includes a target member 259 disposed in the ink chamber 36. The target member 259 includes the pivot center part 61, a first arm 271, a second arm 272, the target portion 62, and the magnet 69, but does not include the float 63. In place of the float 63, the target member 259 is provided with a weight 225. Further, the arrangement of the target member 259 in the ink chamber 36 differs from that in the embodiment. Specifically, the target member 259 is disposed higher in the ink chamber 36 than the target member 59 of the depicted embodiment. In addition, the first arm 271 extends from the pivot center part 61 toward the front wall 40, while the second arm 272 extends from the pivot center part 61 toward the rear wall 41.

The weight 225 is supported on the distal end of the second arm 272. The magnet 69 is provided in an end of the weight 225 facing in the upward direction 54. The weight 225 is formed of a material having a greater specific gravity than the ink stored in the ink chamber 36. The weight 225 has a width larger than the width of the target portion 62 in the leftward direction 56 and rightward direction 55, just like the float 63 of the embodiment.

The target member 259 is capable of pivoting between a detection position shown in FIG. 10B and a standby position shown in FIG. 10A. When the target member 259 is in the standby position, the weight 225 is in contact with the top wall 39 of the ink container 31 due to the magnet 69 being attracted to the magnet 165 of provided in an actuator 260 of the ink cartridge 230. In other words, the weight 225 is positioned higher when the target member 259 is in the standby position than when the target member 259 is in the detection position.

The actuator 260 of the first modification is provided with the first plate 161, a second plate 262, and a third plate 263. However, the position of the magnet 165 is different from that in the embodiment. More specifically, in the first modification, the magnet 165 is disposed in a recess formed in a bottom surface 262B of the second plate 262. That is, the third plate 263 does not include the magnet 165, unlike the embodiment.

The actuator 260 is capable of moving relative to the ink container 31 in the mounting direction 51 and removing direction 52 between a restriction position shown in FIG. 10A and a non-restriction position shown in FIG. 10B.

When the actuator 260 is in the restriction position, the position of the magnet 165 in the mounting direction 51 and removing direction 52 is approximately equal to the position of the magnet 69 provided in the target member 259. In other words, the magnet 165 is positioned in proximity to the magnet 69. At this time, the magnetic force of attraction generated between the magnets 69 and 165 is greater than the gravitational force acting on the weight 225 in the ink (and specifically, the net force on the weight 225 in the downward direction 53 found by subtracting the force of buoyancy from the gravitational force acting on the weight 225). Put another way, the magnet 69 and the magnet 165 define such a distance therebetween that a magnetic field can be generated between the magnet 69 and magnet 165, the magnetic field being greater than the force of gravity of the weight 225 and providing the magnetic force (magnetic field of attraction) acting in a direction opposite the force of gravity.

Consequently, the magnet 69 is attracted to the magnet 165 causing the target member 259 to pivot into the standby position. Hence, the target member 259 is held in the standby position by the magnetic force of attraction (magnetic field) generated between the magnets 69 and 165.

When the actuator 260 is in the non-restriction position, the position of the magnet 165 in the mounting direction 51 and removing direction 52 differs from the position of the magnet 69 provided in the target member 259. That is, the magnet 165 is positioned apart from the magnet 69. In other words, the magnet 165 is moved away from the magnet 69 when the actuator 260 moves from the restriction position to the non-restriction position. Since the distance between the magnets 165 and 69 increases as the actuator 260 moves from the restriction position to the non-restriction position, the magnetic force of attraction generated between the magnets 69 and 165 decreases until the magnetic force of attraction is smaller than the gravitational force acting on the submerged weight 225. Consequently, the target member 259 pivots from the standby position to the detection position as the weight 225 sinks. Hence, the target member 259 is allowed to pivot when the actuator 260 is in the non-restriction position.

The magnet 165 is moved close to the magnet 69 when the actuator 260 moves from the non-restriction position to the restriction position. Since the distance between the magnets 165 and 69 is reduced as the actuator 260 moves from the non-restriction position to the restriction position, the magnetic force of attraction generated between the magnets 69 and 165 increases until the magnetic force of attraction is greater than the gravitational force acting on the submerged weight 225. Thus, the target member 259 is pivoted from the detection position to the standby position by this magnetic force of attraction.

Next, the movements of the target member 259 and actuator 260 as the ink cartridge 230 is being mounted in the cartridge-receiving section 110 will be described. In the following description, the quantity of ink stored in the ink chamber 36 is assumed to be greater than a quantity corresponding to a near-empty condition.

Since an external force is not applied to the actuator 260 prior to the ink cartridge 230 being mounted in the cartridge-receiving section 110, the actuator 260 is in its restriction position. When the actuator 260 is at the restriction position, the target member 259 is held in the standby position by the magnetic force of attraction (magnetic field) generated between the magnets 69 and 165. At this time, at least part of the weight 225 is submerged in the ink stored in the ink chamber 36.

As in the embodiment described above, when the target member 259 is in the standby position, the optical sensor 103 outputs a high level signal to the control unit 130, and the mounting sensor 107 outputs a low level signal to the control unit 130.

In this state, the user opens the cover over the opening 112 formed in the cartridge-receiving section 110 and begins to insert the ink cartridge 230 into the cartridge-receiving section 110.

As the ink cartridge 230 is inserted into the cartridge-receiving section 110 and until the ink-supplying part 60 contacts the inner back surface 151 of the case 101, the ink container 31 and the actuator 260 move together in the mounting direction 51 rather than relative to each other.

As the ink-supplying part 60 moves toward the inner back surface 151 of the case 101 in the mounting direction 51, the ink needle 102 is inserted through the stopper member 68 into the ink-supplying part 60, as illustrated in FIG. 10A. Through this action, ink in the ink chamber 36 is allowed to flow out of the ink cartridge 230.

If a force in the mounting direction 51 is applied to the actuator 260 while the ink-supplying part 60 is in contact with the inner back surface 151 of the case 101, as shown in FIG. 10A, the actuator 260 is moved relative to the ink container 31 in the mounting direction 51 against the biasing force of the coil spring 170. Consequently, the actuator 260 moves from the restriction position to the non-restriction position.

When the actuator 260 moves into the non-restriction position, the engaging end 180A of the locking lever 180 becomes inserted into the recess 164 formed in the second plate 262 of the actuator 260, as shown in FIG. 10B. This arrangement maintains the actuator 260 in the non-restriction position.

Further, as the actuator 260 moves to the non-restriction position, the third plate 263 of the actuator 260 pushes the mounting sensor 107 into its recess, as shown in FIG. 10B. As a result, the mounting sensor 107 outputs a high level signal to the control unit 130, triggering a count for measuring the moving time of the target member 259.

Further, when the actuator 260 moves to the non-restriction position, the magnet 165 provided in the actuator 260 is separated from the magnet 69 provided in the weight 225 of the target member 259, as illustrated in FIG. 10B. This separation reduces the magnetic force of attraction generated between the magnets 165 and 69 until the magnetic force of attraction is smaller than the gravitational force acting on the weight 225 in ink. Consequently, the target member 259 pivots from the standby position to the detection position. Put another way, the movement of the actuator 260 from the restriction position to the non-restriction position causes the magnet 165 to move away from the magnet 69, thereby reducing the magnetic force of attraction generated between the magnets 165 and 69 to move the target member 259 from the standby position to the detection position.

When the target member 259 is in the detection position, the target portion 62 is positioned between the light-emitting element and light-receiving element of the optical sensor 103. Accordingly, light outputted from the light-emitting element does not reach the light-receiving element. Hence, when the target member 259 is in the detection position, the optical sensor 103 outputs a low level signal indicating that the target member 259 is in the detection position. Upon receiving this low level signal, the control unit 130 halts the count for measuring the moving time of the target member 259. After completing the above process, the process of mounting the ink cartridge 230 in the cartridge-receiving section 110 is complete.

Next, the movements of the target member 259 and actuator 260 when the ink cartridge 230 is extracted from the cartridge-receiving section 110 will be described. In the following description, the quantity of ink stored in the ink chamber 36 is assumed to be greater than the quantity corresponding to a near-empty condition.

Once the ink cartridge 230 is completely mounted in the cartridge-receiving section 110, as illustrated in FIG. 10B, the actuator 260 is locked by the locking lever 180 in the non-restriction position. While the actuator 260 is in the non-restriction position, the target member 259 is maintained in the detection position by the gravitational force acting on the weight 225.

To begin extracting the ink cartridge 230 from the cartridge-receiving section 110, the user first presses downward on the operating end 180B of the locking lever 180 to pivotally move the locking lever 180 in a direction of the thick arrow 75 in FIG. 10B. As a result of this pivotal movement, the engaging end 180A of the locking lever 180 is extracted from the recess 164. As a result, the actuator 260 is moved by the biasing force of the coil spring 170 from the non-restriction position to the restriction position shown in FIG. 10A.

When the actuator 260 is in the restriction position, the magnet 165 is positioned near the magnet 69, as shown in FIG. 10A. This proximity increases the magnetic force of attraction generated between the magnets 165 and 69 so that the magnetic force of attraction becomes greater than the gravitational force acting on the weight 225. As a result, the target member 259 is pivotally moved upward from the detection position to the standby position.

Note that, in the first modification, the residual ink determining process described in the embodiment is not performed because the target member 259 remains in the detection position even when the quantity of ink stored in the ink chamber 36 falls below the quantity when the ink cartridge 230 is in a near-empty condition. Further, when the ink cartridge 230 is extracted from the cartridge-receiving section 110 while the quantity of ink in the ink chamber 36 is less than or equal to the quantity when the ink cartridge 230 is in a near-empty condition, the magnetic force of attraction (magnetic field) generated between the magnets 69 and 165 may be, but need not be, set sufficiently strong to pivotally move the target member 259 into the standby position.

### Other Variations of the Embodiment

While both the first and second magnetic bodies are permanent magnets (the magnets 69 and 165) in the depicted embodiment, these magnetic bodies need not be permanent magnets. For example, electromagnets may be used in place of the magnets 69 and 165. Further, one of the magnets 69 and 165 may be a magnetic body formed of metal, such as an iron fragment or nickel fragment.

Although the target member 59 is configured to move by utilizing the magnetic force of attraction generated between the first and second magnetic bodies in the embodiment, the target member 59 may be configured to move by using a magnetic force of repulsion generated between the first and second magnetic bodies. That is, the first and second magnetic bodies may be configured to magnetically repel each other when getting close to each other.

Further, while the target member 59 moves by pivoting between the detection position and standby position in the embodiment, the movement of the target member 59 need not be pivotal motion. For example, the target member 59 may move linearly in the downward direction 53 and upward direction 54 between the detection position and the standby position.

Further, while the actuator 160 is disposed outside of the ink container 31 in the embodiment, the actuator 160 may be provided inside the ink container 31 instead. For example, a portion of the actuator 160 may be arranged outside the ink container 31 while a remaining portion of the actuator 160 is disposed in the ink chamber 36. Here, the actuator 160 may be configured to move relative to the ink container 31 when a force is applied to the portion of the actuator 160 arranged on the outside of the ink container 31.

Further, in the depicted embodiment, the operation of the recording head 21 is restricted, i.e., the control unit 130 skips steps S36, when the moving time of the target member 59 falls outside the threshold range (S18: NO in FIG. 7). In this way, the control unit 130 can prevent occurrence of problems caused by the recording head 21 ejecting ink whose viscosity has changed significantly. However, it is not essential to skip step S36. In other words, the control unit 130 may execute only the process for notifying the user of an abnormality with the ink viscosity (S37) and may leave it up to the user to decide whether or not to allow operations of the recording head 21. While the flow of control by the control unit 130 would differ from that shown in FIGS. 7, 8, and 9 in this case, a detailed description of this flow will not be provided here.

Further, when the control unit 130 determines that the abnormality flag has been set to ON (S32: YES), the control unit 130 may control the head control board 21A to adjust the magnitude of drive voltages applied to the piezoelectric elements 29A of the nozzles 29 in the image-recording process of S36 rather than skipping the processes in S35 and S36.

More specifically, the control unit 130 may modify the control signals outputted to the head control board 21A so that the head control board 21A adjusts the magnitude of drive voltages to be applied to the piezoelectric elements 29A, depending on whether the moving time of the target member 59 falls within or outside the threshold range, in order that the amount of ink ejected from the nozzles 29 is approximately the same (i.e., uniform). Specifically, when the moving time of the target member 59 drops below the lower limit of the threshold range (i.e., when the viscosity of ink is too low), the control unit 130 may apply smaller drive voltages to the piezoelectric elements 29A than when the moving time falls within the threshold range. Conversely, when the moving time of the target member 59 exceeds the upper limit of the threshold range (i.e., when the viscosity of ink is too high), the control unit 130 may apply larger drive voltages to the piezoelectric elements 29A than when the moving time falls within the threshold range.

With this configuration, the drive voltages applied to the piezoelectric elements 29A can be adjusted such that the quantity of ink ejected from the nozzles 29 is approximately uniform. As a result, the control unit 130 can drive the piezoelectric elements 29A using drive voltages suited to the type of ink when a plurality of types of ink cartridges 30 storing ink of differing viscosities may be mounted in the cartridge-receiving section 110, for example. Note that, while the piezoelectric elements 29A are used as one example of the actuating element in the embodiment, but other types of actuating elements can also be used instead of piezoelectric elements. For example, thermal actuators may be used to generate air bubbles in the ink with heat in order to eject ink from the nozzles 29.

Further, the control unit 130 in the embodiment measures the moving time of the target member 59 as follows. Specifically, the control unit 130 starts counting the elapsed period of time in response to a high level signal being outputted from the mounting sensor 107, and halts the count in response to a low level signal being outputted from the optical sensor 103. The control unit 130 then sets the moving time of the target member 59 to the elapsed period of time between the start and end of the counting period. However, the method in which the control unit 130 measures the moving time of the target member 59 is not limited to a counting method. For example, the control unit 130 may set the moving time of the target member 59 to a difference between the time at which the mounting sensor 107 outputs a high level signal and the time at which the optical sensor 103 outputs a low level signal.

In the depicted embodiment, the control unit 130 stores abnormality flags in the EEPROM 134, but the control unit 130 may store these flags in memory on a chip provided in the ink cartridge 30. Further, while the control unit 130 is provided with the CPU 131 and ASIC 135 in the embodiment, the control unit 130 is not limited to this structure. For example, the ASIC 135 may be omitted from the control unit 130, and the CPU 131 may execute all the processes described in FIGS. 7, 8, and 9 by reading programs from the ROM 132. Conversely, the CPU 131 may be omitted from the control unit 130, and the control unit 130 may be configured only of hardware, such as the ASIC 135 and a field-programmable gate array (FPGA). Alternatively, the control unit 130 may be provided with a plurality of CPUs 131 or a plurality of ASICs 135.

Further, while the stopper member 68 seals the opening 66 of the ink supply chamber 65 formed in the ink-supplying part 60 in the above-described embodiment, a valve may be provided in the ink supply chamber 65 in place of the stopper member 68 for selectively opening and closing the opening 66. In this case, when the ink needle 102 is inserted into the ink supply chamber 65, the ink needle 102 moves the valve, opening the opening 66. Conversely, when the ink needle 102 is extracted from the ink supply chamber 65, the valve moves back to its original position to close the opening 66.

Further, while the ink serves as an example of liquid in the embodiment, the liquid may not necessarily be ink, but may be, for example, a pretreatment liquid that is ejected onto the recording sheet prior to the ink during a printing operation.

While the description has been made in detail with reference to specific embodiments thereof, it would be apparent to those skilled in the art that various changes and modifications may be made therein without departing from the scope of the above described embodiments.

What is claimed is:

1. A liquid cartridge comprising:
a liquid container defining a liquid chamber therein for storing liquid;
a target member movably disposed within the liquid chamber, the target member being movable within a predetermined range between a detection position and a standby position, an arrival of the target member at the detection position being detectable from outside of the liquid container;
an actuator movable between a restriction position and a non-restriction position;
a first magnetic body provided on the target member; and
a second magnetic body provided on the actuator,
wherein:
the target member is movable from the standby position to the detection position in response to movement of the actuator from the restriction position to the non-restriction position; and
the target member is movable from the detection position to the standby position in response to movement of the actuator from the non-restriction position to the restriction position.

2. The liquid cartridge as claimed in claim 1, wherein the target member includes a float having a specific gravity smaller than a specific gravity of the liquid stored in the liquid chamber, the float having a buoyancy; and
wherein the first magnet body of the target member positioned at the detection position and the second magnet body of the actuator at the restriction position define such a distance therebetween that a magnetic field can be generated between the first magnet body and the second magnet body, the magnetic field being greater than the buoyancy of the float and providing a magnetic force acting in a direction opposite the buoyancy, the magnetic field generated between the first magnet body and the second magnet body causing the target member to move to the standby position.

3. The liquid cartridge as claimed in claim 2, wherein the magnetic force provided by the magnetic field is a magnetic force that the first magnetic body and the second magnetic body are attracted to each other.

4. The liquid cartridge as claimed in claim 3, wherein the liquid container defines a vertical direction when the liquid cartridge is in a state to be used, the float being positioned lower in the vertical direction when the target member is disposed at the standby position than at the detection position.

5. The liquid cartridge as claimed in claim 4, wherein the actuator is provided outside of the liquid container.

6. The liquid cartridge as claimed in claim 5, wherein the liquid container comprises a first wall and a second wall and a liquid-supplying part provided on the first wall, the liquid chamber being positioned between the first wall and the second wall; and
wherein the actuator comprises a first portion arranged to oppose the second wall.

7. The liquid cartridge as claimed in claim 6, wherein the first portion is positioned closer to the second wall when the actuator is at the non-restriction position than at the restriction position.

8. The liquid cartridge as claimed in claim 7, further comprising a biasing member configured to urge the actuator from the non-restriction position toward the restriction position.

9. The liquid cartridge as claimed in claim 8, wherein the biasing member is provided between the first portion of the actuator and the second wall of the liquid container.

10. The liquid cartridge as claimed in claim 6, wherein the liquid container further comprises a third wall and a fourth wall each connecting between the first wall and the second wall, a portion of the target member being arranged higher than the third wall in the vertical direction.

11. The liquid cartridge as claimed in claim 10, wherein the actuator further comprises:
a second portion extending along the third wall; and
a third portion extending along the fourth wall, the first portion connecting between the second portion and the third portion, the second magnetic body being provided at the third portion.

12. The liquid cartridge as claimed in claim 11, further comprising a biasing member disposed between the second wall and the first portion, the biasing member being configured to urge the first portion in a direction away from the second wall.

13. The liquid cartridge as claimed in claim 2, wherein the first magnetic body is provided on the float.

14. The liquid cartridge as claimed in claim 13, wherein the target member further includes a target portion having a width in a width direction perpendicular to a direction in which the target member moves from the standby position to the detection position, an arrival of the target portion at the detection position being detectable from outside of the liquid container; and
wherein the float has a width larger than the width of the target portion in the width direction.

15. The liquid cartridge as claimed in claim 1, wherein the target member includes a weight having a specific gravity larger than a specific gravity of the liquid stored in the liquid chamber, the weight having a force of gravity; and
wherein the first magnet body of the target member positioned at the detection position and the second magnet body of the actuator at the restriction position define such a distance therebetween that a magnetic field can be generated between the first magnet body and the second magnet body, the magnetic field being greater than the force of gravity of the weight and providing a magnetic force acting in a direction opposite the force of gravity, the magnetic field generated between the first magnet body and the second magnet body causing the target member to move to the standby position.

16. The liquid cartridge as claimed in claim 15, wherein the magnetic force provided by the magnetic field is a magnetic force that the first magnetic body and the second magnetic body are attracted to each other.

17. The liquid cartridge as claimed in claim 16, wherein the liquid container defines a vertical direction when the liquid cartridge is in a state to be used, the weight being positioned higher in the vertical direction when the target member is disposed at the standby position than at the detection position.

18. The liquid cartridge as claimed in claim 17, wherein the actuator is provided outside of the liquid container.

19. The liquid cartridge as claimed in claim 18, wherein the liquid container comprises a first wall and a second wall and a liquid-supplying part provided on the first wall, the liquid chamber being positioned between the first wall and the second wall; and
wherein the actuator comprises a first portion arranged to oppose the second wall.

20. The liquid cartridge as claimed in claim 19, wherein the first portion is positioned closer to the second wall when the actuator is at the non-restriction position than at the restriction position.

21. The liquid cartridge as claimed in claim 20, further comprising a biasing member configured to urge the actuator from the non-restriction position toward the restriction position.

22. The liquid cartridge as claimed in claim 21, wherein the biasing member is provided between the first portion of the actuator and the second wall of the liquid container.

23. The liquid cartridge as claimed in claim 19, wherein the liquid container further comprises a third wall and a fourth wall each connecting between the first wall and the second wall, a portion of the target member being configured to be arranged higher than the third wall in the vertical direction.

24. The liquid cartridge as claimed in claim 23, wherein the actuator further comprises:
a second portion extending along the third wall; and
a third portion extending along the fourth wall, the first portion connecting between the second portion and the third portion, the second magnetic body being provided at the second portion.

25. The liquid cartridge as claimed in claim 24, further comprising a biasing member disposed between the second wall and the first portion, the biasing member being configured to urge the first portion in a direction away from the second wall.

26. The liquid cartridge as claimed in claim 15, wherein the first magnetic body is provided on the weight.

27. The liquid cartridge as claimed in claim 26, wherein the target member further includes a target portion having a width in a width direction perpendicular to a direction in which the target member moves from the standby position to the detection position, an arrival of the target portion at the detection position being detectable from outside of the liquid container; and
wherein the weight has a width larger than the width of the target portion in the width direction.

28. The liquid cartridge as claimed in claim 1, wherein the target member is configured to pivotally move between the standby position and the detection position.
